(19) United States
(12) Patent Application Publication
(10) Pub. No.: US 2025/0215589 A1
(43) Pub. Date: Jul. 3, 2025

(54) MEMBRANE-EMBEDDED GAS DIFFUSION ELECTRODE FOR REACTANT VALORIZATION

(71) Applicant: Turnover Technologies, Inc., Brooklyn, NY (US)

(72) Inventors: Marissa BEATTY, New York, NY (US); Amanda F. BAXTER, Brooklyn, NY (US)

(73) Assignee: Turnover Technologies, Inc., Brooklyn, NY (US)

(21) Appl. No.: 19/001,827

(22) Filed: Dec. 26, 2024

Related U.S. Application Data
(60) Provisional application No. 63/615,032, filed on Dec. 27, 2023.
(60) Provisional application No. 63/737,135, filed on Dec. 20, 2024.

(51) Int. Cl. C25B 11/032; C25B 11/065; C25B 11/081; C25B 13/07

(52) U.S. Cl. CPC C25B 11/032; C25B 11/065; C25B 11/081; C25B 13/07

(57) ABSTRACT

The present disclosure discloses and includes a membrane-embedded gas diffusion electrode (ME-GDE) apparatus for the electrochemical valorization of one or more reactant species, comprising an electronically conductive support material, a catalytic phase, a membrane phase, and an ion-conducting phase, wherein the catalytic phase is embedded in the ion-conducting phase, and wherein the ion-conducting phase is in contact with the electronically conductive support material.

### CROSS-REFERENCE TO RELATED APPLICATIONS

This application claims the benefit of U.S. Provisional Application No. 63/615,032, filed Dec. 27, 2023, and U.S. Provisional Application No. 63/737, 135, filed Dec. 20, 2024, both of which are incorporated by reference herein in their entireties.

### BACKGROUND OF THE INVENTION

Gas diffusion electrodes (GDEs) play an industrially relevant role in the electrochemical valorization of gas- and liquid-phase reactant species. GDEs are typically a component of a larger fuel cell or electrolyzer assembly that employs an electrical potential to facilitate an electrochemical reaction. Conventional GDEs comprise a conducting mechanical support material, an ion conducting phase, and a catalytic phase. GDEs are further designed to separate a diffusion layer from an active layer. Specifically, the diffusion layer facilitates the movement of reactant and product species in the direction towards and away from the active layer. The diffusion layer comprises the conducting mechanical support material, which may contain macroporous and microporous regions with correspondingly sized channels or pores. The active layer is the region wherein the electrochemical reaction occurs, and comprises an ion-conducting phase and catalyst nanoparticles that are immobilized upon synthesis.

GDEs have historical and contemporary applications. For example, GDEs have an established role in the industrial synthesis of chlorine and sodium hydroxide via the chlor-alkali process. In contemporary application, in view of increasing concentrations of atmospheric greenhouse gases, GDEs have been studied for the CO₂ electroreduction reaction (CO₂RR). In the case of assemblies that employ GDEs for CO₂RR, addressing several confounding operational limitations has been an active focus of the research community. Such limitations include, but are not limited to, catalyst agglomeration, catalyst dissolution, catalyst detachment, catalyst poisoning, overpotential losses, competing reactions at relevant operating potentials, low reactant or product solubility, and product stream separation. In the current state, these limitations have restricted the economic viability of GDEs in assemblies for CO₂RR. Therefore, there remains a need to develop techniques that stabilize the catalyst, tune reaction selectively, and decrease operational inefficiencies related to overpotential losses and product stream separation.

### SUMMARY

The present disclosure provides for, and includes membrane-embedded gas diffusion electrodes (ME-GDE) and methods for making such. In an aspect, the present disclosure provides a ME-GDE, comprising: an electronically conductive support material; a catalytic phase; a membrane phase; and an ion-conducting phase; wherein the catalytic phase is dispersed in the ion-conducting phase, and wherein the ion-conducting phase is in contact with the electronically conductive support material.

In an aspect, the present disclosure provides a membrane-embedded gas diffusion electrode (ME-GDE), comprising: an electronically conductive support material comprising nanostructured carbon; a catalytic phase comprising Ag; a membrane phase comprising SiO₂; and an ion-conducting phase comprising Sustainion XA-9; wherein the membrane phase encapsulates the catalytic phase, and wherein the catalytic phase is dispersed in the ion-conducting phase.

In an aspect, the present disclosure provides a membrane-embedded gas diffusion electrode (ME-GDE), comprising: an electronically conductive support material; a catalytic phase; and a membrane phase; wherein the catalytic phase is in contact with the electronically conductive support material.

In an aspect, the present disclosure provides a membrane-embedded gas diffusion electrode (ME-GDE), comprising: an electronically conductive support material comprising carbon paper; a catalytic phase comprising Ag; a membrane phase comprising SiO2 or TiO2; and an ion-conducting phase comprising Sustainion XA-9; wherein the membrane phase encapsulates the catalytic phase and the electronically conductive support material, and wherein the ion-conducting phase is distributed within the catalytic phase and the electronically conductive support material.

### BRIEF DESCRIPTION OF THE DRAWINGS

Aspects of the disclosure are herein described, by way of example only, with reference to the accompanying drawings. With specific reference now to the drawings in detail, it is stressed that the particulars shown are by way of example and are for purposes of illustrative discussion of aspects of the disclosure. In this regard, the description and the drawings, considered alone and together, make apparent to those skilled in the art how aspects of the disclosure may be practiced.

FIG. 1 illustrates an exemplary membrane embedded electrode according to the present disclosure, operating in the context of an electrolytic cell.

FIG. 2. illustrates an example of the electrode according to the present disclosure where the membrane is in direct contact with the catalyst phase, conductive support, and ion-conducting phase.

FIG. 3 illustrates a cross section of an electrode according to the present disclosure where the membrane is in direct contact with the catalyst phase, conductive support, and ion-conducting phase.

FIG. 4. illustrates examples of conductive support geometries applicable to the present disclosure.

FIG. 5. illustrates examples of catalyst nanoparticle geometries.

FIG. 6 illustrates a cross section of the electrode according to the present disclosure where the membrane is in direct contact with the catalyst phase and conductive support and the membrane phase is present as a conformal and continuous coating around all phases.

FIG. 7 Illustrates a cross section of the electrode according to the present disclosure where the membrane is in direct contact with the catalyst phase and conductive support and the membrane phase is present as a non-conformal coating around all phases.

FIG. 8 illustrates a cross section of an electrode according to the present disclosure where the membrane encapsulates the catalyst phase, and is in direct contact with the conductive support, and the ion-conducting phase is in direct contact with the membrane phase.

FIG. 9 illustrates a cross section of an electrode according to the present disclosure where the catalyst phase is in direct contact with the electronically conducting phase, both of which are encapsulated by the membrane phase, which is in direct contact with the ion-conducting phase.

FIG. 10 illustrates a cross section of an electrode according to the present disclosure wherein the catalyst phase is in direct contact with both the conductive support material and the ion-conducting phase, and all of which is encapsulated within the membrane phase, which may or may not be in contact with the conductive support or catalyst phase.

FIG. 11 illustrates an example electrode according to the present disclosure, comprising a membrane-encapsulated catalytic phase in direct contact with an ion-conducting phase, embedded within or deposited onto an electronically conductive support material.

FIG. 12 illustrates an example electrode according to the present disclosure, comprising a catalytic phase in direct contact with an ion-conducting phase, wherein the ion-conducting phase is in direct contact with and encapsulated by a membrane phase, embedded within or deposited onto an electronically conductive support material.

FIG. 13 illustrates an example electrode according to the present disclosure, comprising a catalytic phase in direct contact with the membrane phase, and an ion-conducting phase that is in direct contact with and encapsulated by a membrane phase, embedded within or deposited onto an electronically conductive support material.

FIG. 14 illustrates an example electrode according to the present disclosure, comprising a catalytic phase in direct contact with an ion-conducting phase the membrane phase is interspersed within or fully encapsulates the macroporous, mesoporous and/or microporous region of an electronically conductive support material, and is not in direct contact with the catalytic phase or the ion-conducting phase.

FIG. 15 illustrates an example electrode according to the present disclosure comprising a catalytic phase embedded within an electronically conductive support material, which are both encapsulated by a membrane phase that is in direct contact with an ion-conducting phase.

FIG. 16 illustrates an example electrode according to the present disclosure comprising a catalytic phase embedded within or deposited onto an electronically conductive support material, wherein the membrane phase is in contact with the ion-conducting phase and conductive support material, but may or may not be in direct contact with the catalytic phase.

FIG. 17A illustrates a composite Scanning Electron Microscopy Energy Dispersive X-ray Spectroscopy (SEM-EDS) image of exemplary encapsulated Ag nanoparticles supported on carbon synthesized using a sol-gel method described herein.

FIG. 17B illustrates the SEM-EDS image of exemplary encapsulated Ag nanoparticles supported on carbon synthesized using a sol-gel method described herein, showing only the Ag.

FIG. 17C illustrates the SEM-EDS image of exemplary encapsulated Ag nanoparticles supported on carbon synthesized using a sol-gel method described herein, showing only the carbon.

FIG. 17D illustrates the SEM-EDS image of exemplary encapsulated Ag nanoparticles supported on carbon synthesized using a sol-gel method described herein, showing only the oxygen.

FIG. 17E illustrates the SEM-EDS image of exemplary encapsulated Ag nanoparticles supported on carbon synthesized using a sol-gel method described herein, showing only the silicon.

FIG. 18A illustrates the composite SEM image (top) of Ag nanoparticles supported on carbon paper and embedded in ionomer and the SEM-EDS images of silver (bottom left) and carbon (bottom right).

FIG. 18B illustrates the composite SEM image (top) of Ag nanoparticles supported on carbon paper, embedded in ionomer and encapsulated in an SiO₂ layer (as depicted in FIG. 10), and the SEM-EDS images of silver (bottom left), carbon (bottom center) and silicon (bottom right).

FIG. 19A illustrates the EDS spectrum of Ag nanoparticles deposited on a carbon paper substrate before silicon oxide encapsulation.

FIG. 19B illustrates the EDS spectrum of Ag nanoparticles deposited on a carbon paper substrate after silicon oxide encapsulation by a sol-gel method.

FIG. 20A illustrates a zoomed out view of bare carbon paper.

FIG. 20B illustrates a zoomed out view of Ag deposited on carbon paper by an exemplary method described herein.

FIG. 20C illustrates a zoomed out view of Ag deposited on carbon paper and encapsulated with silicon oxide by a sol gel method described herein.

FIG. 20D illustrates a zoomed in view of bare carbon paper.

FIG. 20E illustrates a zoomed in view of bare Ag deposited on carbon paper by an exemplary method described herein.

FIG. 20F illustrates a zoomed in view of Ag deposited on carbon paper and encapsulated with silicon oxide by a sol gel method described herein.

FIG. 21 illustrates a linear sweep voltammogram of Ag with ionomer on carbon paper before and after SiO₂ encapsulation, prepared using an exemplary method described herein.

FIG. 22 illustrates a linear sweep voltammogram of Ag with ionomer on carbon paper before and after TiO₂ encapsulation, prepared using an exemplary method described herein.

FIG. 23A illustrates changes in selectivity for different ME-GDEs prepared using the exemplary methods described herein, measured by Faradaic efficiency.

FIG. 23B illustrates changes in selectivity for different ME-GDEs prepared using the

exemplary methods described herein, measured by partial current density.

FIG. 24 illustrates electrochemical performance of SiO₂ encapsulated Ag in the presence of pure CO₂ vs CO₂/air mixture.

### DETAILED DESCRIPTION

The present disclosure includes and describes a membrane-embedded gas diffusion electrode (ME-GDE) apparatus for the valorization of one or more reactant species, comprising an electronically conductive support material, a catalytic phase, a membrane phase, and a solid or amorphous ion-conducting phase, wherein the catalytic phase is embedded in the ion-conducting phase, and wherein the ion-conducting phase is in contact with the electronically conductive support material. This description is not intended to be a detailed catalog of all the different ways in which the

disclosure may be implemented, or all the features that may be added to the instant disclosure. For example, features illustrated with respect to one embodiment may be incorporated into other embodiment, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. In other instances, well-known structures, interfaces, and processes have not been shown in detail in order not to unnecessarily obscure the invention. It is intended that no part of this specification be construed to effect a disavowal of any part of the full scope of the invention. Hence, the following descriptions are intended to illustrate some particular embodiments of the disclosure, and not to exhaustively specify all permutations, combinations and variations thereof.

Unless otherwise defined, all technical and scientific terms used herein have the same meaning as commonly understood by one of ordinary skill in the art to which this disclosure belongs. The terminology used in the description of the disclosure herein is for the purpose of describing particular aspects or embodiments only and is not intended to be limiting of the disclosure.

All publications, patent applications, patents and other references cited herein are incorporated by reference in their entireties for the teachings relevant to the sentence and/or paragraph in which the reference is presented. References to techniques employed herein are intended to refer to the techniques as commonly understood in the art, including variations on those techniques or substitutions of equivalent techniques that would be apparent to one of skill in the art.

Unless the context indicates otherwise, it is specifically intended that the various features of the disclosure described herein can be used in any combination. Moreover, the present disclosure also contemplates that in some embodiments of the disclosure, any feature or combination of features set forth herein can be excluded or omitted.

The methods disclosed herein include and comprise one or more steps or actions for achieving the described method. The method steps and/or actions may be interchanged with one another without departing from the scope of the present disclosure. In other words, unless a specific order of steps or actions is required for proper operation of the embodiment, the order and/or use of specific steps and/or actions may be modified without departing from the scope of the present disclosure.

As used in the description of the disclosure and the appended claims, the singular forms “a,” “an” and “the” are intended to include the plural forms as well, unless the context clearly indicates otherwise.

As used herein, “and/or” refers to and encompasses any and all possible combinations of one or more of the associated listed items, as well as the lack of combinations when interpreted in the alternative (“or”).

The terms “about” and “approximately” as used herein when referring to a measurable value such as a length, a frequency, or a measurement value and the like, is meant to encompass variations of ±20%, ±10%, ±5%, ±1%, ±0.5%, or even ±0.1% of the specified amount.

As used herein, phrases such as “between X and Y” and “between about X and Y” should be interpreted to include X and Y. As used herein, phrases such as “between about X and Y” mean “between about X and about Y” and phrases such as “from about X to Y” mean “from about X to about Y.”

The terms “comprise,” “comprises,” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the specified materials or steps recited in the claim and those that do not materially affect the basic and novel characteristic(s) of the claimed disclosure. Thus, the term “consisting essentially of” when used in a claim of this disclosure is not intended to be interpreted to be equivalent to “comprising.”

As used herein, the term “exemplary” is used to mean serving as an example, instance, or illustration. Any embodiment or aspect described as “exemplary” is not necessarily to be construed as preferred or advantageous over other embodiments or aspects, nor is it meant to preclude equivalent structures and techniques known to those of ordinary skill in the art. Rather, use of the word exemplary is intended to present concepts in a concrete fashion, and the disclosed subject matter is not limited by such examples.

The present disclosure provides for and includes a membrane-embedded gas diffusion electrode (ME-GDE) apparatus for the electrochemical valorization of one or more reactants, comprising an electronically conductive support material, a catalytic phase, a membrane phase, and an ion-conducting phase. In an aspect, the catalytic phase is embedded in the ion-conducting phase. In an aspect the ion-conducting phase is in contact with the electronically conductive support material.

As used herein, a “gas diffusion electrode” or “GDE” is an electrode with a conjunction of a solid, liquid, and an aqueous or gaseous interface, with catalyst catalyzing an electrochemical reaction between the liquid and the aqueous or gaseous phase. Without being bound by theory, a GDE uses a porous catalyst phase along with diffusion media to facilitate transport and distribution of a reactant that is dissolved in the aqueous or in a gaseous phase. This increases the reaction rate for reactants that have low solubility in liquid phase. In an aspect, a GDE is a cathode. In an aspect, a GDE is an anode. In an aspect, a GDE is membrane-embedded.

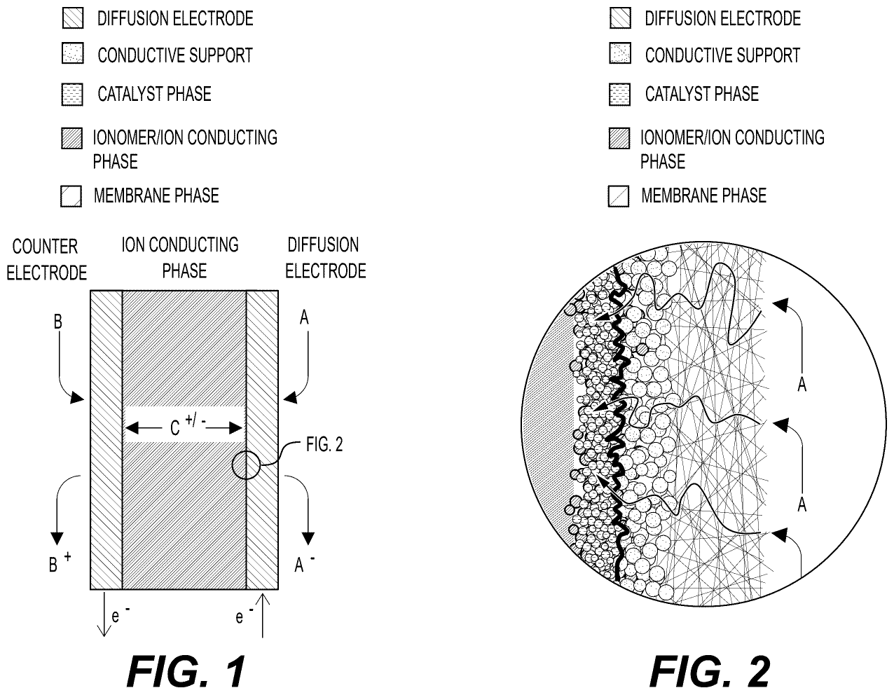

An exemplary membrane embedded electrode disclosed herein can be used in the context of an electrolytic cell (FIG. 1). As shown in FIG. 1, a chemical species “A” diffuses through the conductive support and membrane phase to be electrochemically reduced at a catalyst surface, and the membrane embedded electrode is ionically connected through an ion conducting phase to a counter electrode performing the corresponding balance oxidation reaction to drive electrolysis.

An exemplary membrane embedded electrode disclosed herein can also have a different geometry. As shown in FIG. 2, the membrane may be in direct contact with the catalyst phase, conductive support, and ion-conducting phase, and a chemical species “A” is diffusing through the conductive support and embedded membrane to access the catalytic phase of the electrode for electrochemical reaction.

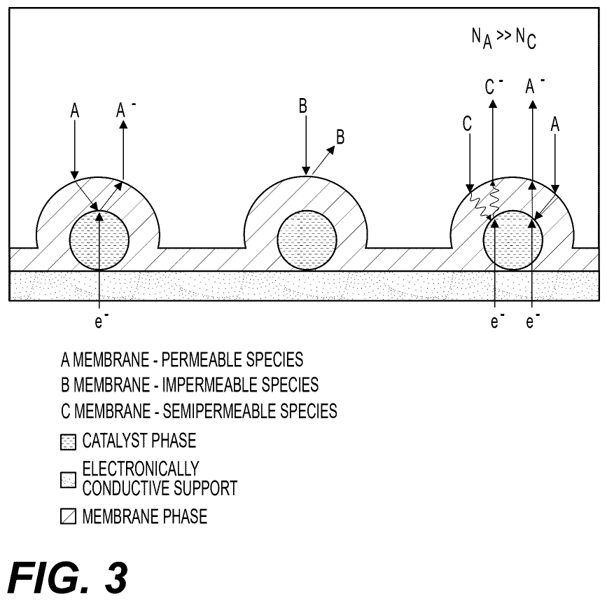

An exemplary membrane embedded electrode disclosed herein can also have a membrane in direct contact with the catalyst phase, conductive support, and ion-conducting phase (FIG. 3). Here, a chemical species “A” is diffusing through the conductive support and embedded membrane to access the catalytic phase of the electrode for electrochemical reaction. Simultaneously, an impermeable species “B” is unable to permeate the membrane phase and is unable to access the catalyst phase for reduction, and a semi-permeable species “C” permeates the membrane phase alongside permeable species “A”, but does so with a flux (N_{C}) much lower than species A's flux (N_{A}).

As used herein, “dispersed” is defined as being spatially distributed over an area. As used herein, “embedded” is defined as being spatially located within a separate distinct phase. In an aspect, “in contact” is defined as a phase being in physical or chemical communication with another distinct phase.

In an aspect, a GDE is used for valorization. As used herein, “valorization” is the process of reusing, recycling or adding value to compounds and converting them into more useful products. In an aspect, a GDE is used in a carbon capture and conversion assembly. In an aspect, a GDE is used for reducing CO₂ into industrially relevant fuels and chemicals. In an aspect, a GDE is used for reducing CO₂ into CO, C₁-C₅ alkanes, or C₁-C₅ alkenes, or C₁-C₅ alcohols. In an aspect, a GDE is used for the reduction of CO₂ present in a point source emission. In an aspect, a GDE is used for the reduction of CO₂ present in flue gas.

### Membrane Phase

In an aspect, a GDE described herein comprises a membrane phase. As used herein, a “membrane phase” is defined as a distinguishable region that acts as a selective barrier for the movement of molecules, ions, atoms, and/or other relevant species. In an aspect, the membrane phase is selective for molecules, ions, atoms, and/or other relevant species. In an aspect, the selectivity of a GDE is based on a physical property of the species. In an aspect, the selectivity of a GDE is based on a chemical property of the species. In an aspect, the selectivity of a GDE is based on charge, size, phase, potential, and/or pressure.

In an aspect, the membrane phase comprises one or more oxides. In an aspect, the membrane phase comprises one or more oxides that include, but are not limited to, MnO, Mn₂O₃, Mn₃O₄, MnO₂, MgO, MgO₂, SiO, SiO₂, CeO₂, TiO₂, SnO₂, Al₂O₃, and ZrO₂. In an aspect, an oxide comprises a transition metal oxide. In an aspect, an oxide comprises a post-transition metal oxide. In an aspect, an oxide comprises a rare earth lanthanide metal oxide. In an aspect, an oxide comprises a metalloid oxide.

In an aspect, the membrane phase comprises one or more organic polymers. In an aspect, the membrane phase comprises one or more organic polymers that include, but are not limited to, PDMS, organo-siloxane composites, SDS, poly-tetrafluoroethylene, TEOS, cellulose acetates, polyamides, polyimides, and polysulfones. In an aspect, the membrane phase is coated with a wetting agent. As used herein, a “wetting agent” is a chemical species or surface modification that alters the surface tension of a material. In an aspect, wetting agent includes, but is not limited to, fluorinated polymers, polyvinylidene fluoride (PVDF), polytetrafluoroethylene (PTFE), fluorinated ethylene propylene (FEP), polyvinylchloride (PVC), perfluoroalkoxy polymer resin (PFA), and polychlorotrifluoroethylene (PCTFE).

As used herein, “distinct” means distinguishable, whether it be based on form, feature, element, phase, composition, or any other property. In an aspect, the membrane phase comprises two or more distinct layers. In an aspect, the membrane phase comprises two or more compositionally distinct layers. In an aspect, the membrane comprises two compositionally distinct layers deposited in temporal succession. In an aspect, the membrane comprises two compositionally distinct layers deposited at different times; wherein the first membrane layer comprises an oxide, and the second membrane layer comprises an organic polymer. In an aspect, the membrane comprises two compositionally distinct layers deposited at different times; wherein the first membrane layer comprises an oxide, and the second membrane layer comprises an oxide. In an aspect, the first membrane layer comprises an oxide, and the second membrane layer comprises an organic polymer. In an aspect, the membrane comprises three compositionally distinct layers deposited at different times. In an aspect, the membrane comprises two compositionally distinct layers deposited at the same time. In an aspect, the membrane comprises two compositionally distinct layers deposited at the same time, and a third layer deposited at a different time. In an aspect, the membrane phase comprises two or more compositionally identical layers. In an aspect, the membrane comprises two or more compositionally identical or distinct layers deposited at different times.

In an aspect, the surface of the membrane phase is modified with one or more functional groups selected from the group consisting of imidazoles, amines, and amides. As used herein, a phase or surface is “modified” by the addition of a chemical species to a material phase or surface, imparting upon that phase or surface new functions or properties. In an aspect, a membrane phase is modified to impart permselectivity. In an aspect, a membrane phase is modified to immobilize a catalyst nanoparticle.

In an aspect, the membrane phase is permselective. In an aspect, the membrane phase is permeable to one or more ions. In an aspect, the membrane phase is permeable to one or more ions selected from the group consisting of H⁺, OH⁻, CO₂H⁻, and CO₃²⁻. In an aspect, the membrane phase is permeable to one or more molecules. In an aspect, the membrane phase is permeable to one or more molecules selected from the group consisting of CO, CO₂, H₂O, and C₁-C₄ alcohols. In an aspect, the membrane phase is impermeable to one or more molecules selected from the group consisting of NO, O₂, C₁-C₆ alkanes, C₁-C₆ alkenes, and C₁-C₆ alkynes. In an aspect, the membrane phase is impermeable to one or more ions selected from the group consisting of S²⁻, SO₃²⁻, SO₄²⁻, NO₂⁻, NO₃⁻, PO₄³⁻, PO₃H²⁻, F⁻, Cl⁻, Br⁻, and I⁻. In an aspect, the membrane phase is impermeable to one or more molecules. In an aspect, the membrane phase is impermeable to one or more molecules selected from the group consisting of O₂, C₁-C₆ alkanes, C₁-C₆ alkenes, and C₁-C₆ alkynes.

In an aspect, the membrane phase is impermeable to heavy metal ions. In an aspect, the membrane phase is impermeable to heavy metal ions that include, but are not limited to, atomically charged chromium (Cr), iron (Fe), copper (Cu), zinc (Zn), niobium (Nb), molybdenum (Mo), silver (Ag), cadmium (Cd), platinum (Pt), palladium (Pd), mercury (Hg), and lead (Pb).

In an aspect, the membrane phase is impermeable to heavy metals. In an aspect, the membrane phase is impermeable to heavy metals that include, but are not limited to, chromium (Cr), iron (Fe), copper (Cu), zinc (Zn), niobium (Nb), molybdenum (Mo), silver (Ag), cadmium (Cd), platinum (Pt), palladium (Pd), mercury (Hg), and lead (Pb).

In an aspect, the membrane phase is impermeable to metalloids. In an aspect, metalloids include but are not limited to boron (B) and arsenic (As).

### Membrane Geometries and Designs

The present disclosure includes and provides exemplary designs and geometries for membrane phases in a GDE. The geometry for the membrane phase may be used as a variable to optimize for GDEs with particular functions. In an aspect, the position of the membrane phase relative to the catalytic phase is varied.

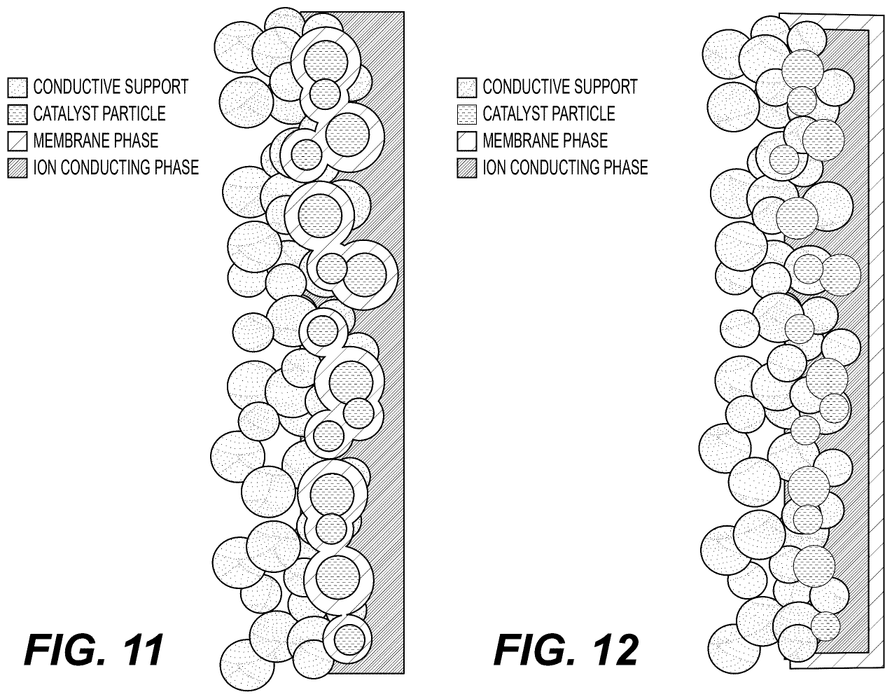

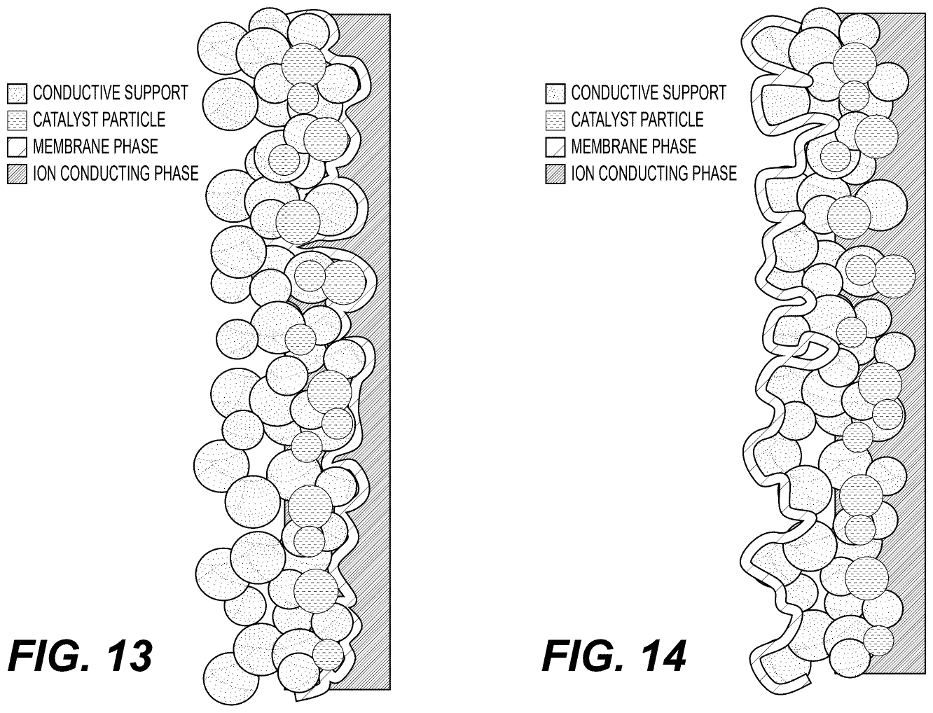

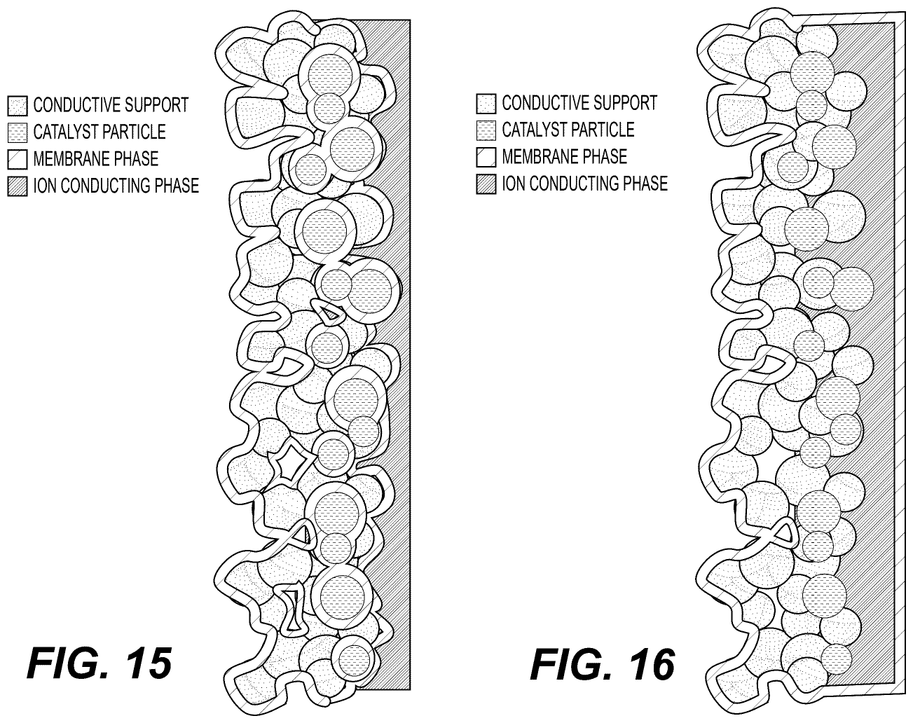

In an aspect, the membrane phase covers or encapsulates the catalytic phase (FIG. 8, FIG. 9, FIG. 11, FIG. 13, FIG. 15). Without being bound by theory, encapsulating or covering the catalytic phase with the membrane phase may increase particle stability or adherence of the catalytic particles to the conductive mechanical support, thus slowing the loss of catalyst particles through detachment. Without being bound by theory, encapsulating or covering the catalytic phase with the membrane phase may also preserve catalyst surface structure, particle size, and distribution of nanoparticles along the conductive support. Without being bound by theory, the membrane phase may also extend performance lifetimes of electrode assembly by preventing the agglomeration of catalyst nanoparticles, and the subsequent loss of electrochemically active surface area. Without being bound by theory, the membrane phase may mitigate catalyst poisoning by feedstock contaminants. Without being bound by theory, the thickness of the membrane phase may be synthesized to tune porosity or selectivity for the electrochemical reaction of interest. Without being bound by theory, the composition of the membrane phase may be synthesized to tune porosity or selectivity for the electrochemical reaction of interest. Without being bound by theory, the structure of the membrane phase may be synthesized to tune porosity or selectivity for the electrochemical reaction of interest.

In an aspect, the membrane phase covers part of the catalytic phase. As used herein, a membrane “covers” another phase when it extends over the surface of the other phase. In an aspect, the membrane phase covers less than 100% of the surface of the catalytic phase. In an aspect, the membrane phase covers less than about 20% of the catalytic phase. In an aspect, the membrane phase covers between about 20% to about 40% of the catalytic phase. In an aspect, the membrane phase covers between about 40% to about 60% of the catalytic phase. In an aspect, the membrane phase covers between about 60% to about 80% of the catalytic phase. In an aspect, the membrane phase covers more than about 80% of the catalytic phase. In an aspect, the membrane phase covers about 25% of the catalytic phase. In an aspect, the membrane phase covers about 50% of the catalytic phase. In an aspect, the membrane phase covers about 75% of the catalytic phase.

In an aspect, the membrane phase encapsulates the catalytic phase. As used herein, a membrane “encapsulates” another phase when it covers the majority of the surface of the other phase. In an aspect, a membrane encapsulates another phase when it covers more than 50% of the other phase. In an aspect, a membrane encapsulates another phase when it covers at least 51% of the other phase. In an aspect, a membrane encapsulates another phase when it covers at least 60% of the other phase. In an aspect, a membrane encapsulates another phase when it covers at least 70% of the other phase. In an aspect, a membrane encapsulates another phase when it covers at least 80% of the other phase. In an aspect, a membrane encapsulates another phase when it covers at least 90% of the other phase. In an aspect, a membrane encapsulates another phase when it covers at least 95% of the other phase. In an aspect, a membrane encapsulates another phase when it covers at least 97% of the other phase. In an aspect, a membrane encapsulates another phase when it covers at least 99% of the other phase. In an aspect, a membrane encapsulates another phase when it covers approximately 100% of the other phase.

In an aspect, the membrane phase fully encapsulates the catalytic phase and has a thickness in the range of about 2 nm to about 30 nm. In an aspect, the membrane phase fully encapsulates the catalytic phase and has a thickness in the range of about 2 nm to about 6 nm. In an aspect, the membrane phase fully encapsulates the catalytic phase and has a thickness in the range of about 6 nm to about 12 nm. In an aspect, the membrane phase fully encapsulates the catalytic phase and has a thickness in the range of about 12 nm to about 30 nm. In an aspect, the membrane phase fully encapsulates the catalytic phase and has a thickness in the range of about 4 nm to about 25 nm. In an aspect, the membrane phase fully encapsulates the catalytic phase and has a thickness in the range of about 6 nm to about 20 nm. In an aspect, the membrane phase fully encapsulates the catalytic phase and has a thickness of at least 2 nm. In an aspect, the membrane phase fully encapsulates the catalytic phase and has a thickness of at least 5 nm. In an aspect, the membrane phase fully encapsulates the catalytic phase and has a thickness of at least 10 nm. In an aspect, the membrane phase fully encapsulates the catalytic phase and has a thickness of at least 12 nm. In an aspect, the membrane phase fully encapsulates the catalytic phase and has a thickness of at least 15 nm. In an aspect, the membrane phase fully encapsulates the catalytic phase and has a thickness of at least 18 nm. In an aspect, the membrane phase fully encapsulates the catalytic phase and has a thickness of at least 20 nm. In an aspect, the membrane phase fully encapsulates the catalytic phase and has a thickness of at least 23 nm. In an aspect, the membrane phase fully encapsulates the catalytic phase and has a thickness of at least 25 nm. In an aspect, the membrane phase fully encapsulates the catalytic phase and has a thickness of at least 28 nm.

In an aspect, the thickness of the membrane phase is tuned to suppress one or more competing electrochemical reactions. As used herein, “competing electrochemical reactions” are side reactions that occur at the same time or within the same conditions as the main reaction, and compete with the main reaction for reactant species. In an aspect, competing electrochemical reactions include but are not limited to the methane oxidation reaction, methanol oxidation reaction (MOR), ethanol oxidation reaction (EOR), hydrogen oxidation reaction (HOR), hydrogen evolution reaction (HER), chlorine evolution reaction (CER), oxygen evolution reaction (OER), and oxygen reduction reaction (ORR).

In an aspect, the membrane phase is in direct contact with the ion-conducting phase (FIG. 10, FIG. 12, FIG. 16). Without being bound by theory, synthesizing the membrane phase to be in direct contact with the ion-conducting phase may mitigate catalyst poisoning by feedstock contaminants. Without being bound by theory, synthesizing the membrane phase to be in direct contact with the ion-conducting phase may decrease the operating energy consumption of the GDE by maintaining electrochemically active surface area. Without being bound by theory, synthesizing the membrane phase to be in direct contact with the ion-conducting phase may increase the purity of product streams when implemented into an electrolyzer device. Without being bound by theory, the thickness of the membrane phase may be synthesized to tune porosity or selectivity for the reaction of interest.

In an aspect, the membrane phase covers part of the ion-conducting phase. In an aspect, the membrane phase covers less than about 20% of the ion-conducting phase. In an aspect, the membrane phase covers between about 20% to about 40% of the ion-conducting phase. In an aspect, the membrane phase covers between about 40% to about 60% of the ion-conducting phase. In an aspect, the membrane phase covers between about 60% to about 80% of the ion-conducting phase. In an aspect, the membrane phase covers more than about 80% of the ion-conducting phase. In an aspect, the membrane phase covers approximately 25% of the ion-conducting phase. In an aspect, the membrane phase covers approximately 50% of the ion-conducting phase. In an aspect, the membrane phase covers approximately 75% of the ion-conducting phase. In an aspect, the membrane phase fully encapsulates the ion-conducting phase, i.e., covers approximately 100% of the ion-conducting phase.

In an aspect, the membrane phase is interspersed in the electronically conductive support material (FIG. 9, FIG. 10, FIG. 12, FIG. 14, FIG. 16). In an aspect, the membrane phase is interspersed in the electronically conductive support material and is not in direct contact with the ion-conducting phase (FIG. 14). Without being bound by theory, synthesizing the membrane phase to be interspersed within the conductive support material may mitigate catalyst poisoning and support fouling by feedstock contaminants. Without being bound by theory, synthesizing the membrane phase to be interspersed within the conductive support material may decrease the operating energy consumption of the GDE by maintaining electrochemically active surface area. Without being bound by theory, synthesizing the membrane phase to be interspersed within the conductive support material may increase the purity of product streams. Without being bound by theory, the thickness of the membrane phase may be synthesized to tune porosity or selectivity for the reaction of interest.

In an aspect, the membrane phase partially covers the electronically conductive support material (FIG. 1, FIG. 15). Without being bound by theory, synthesizing the membrane phase to partially cover the electronically conductive support material may mitigate catalyst poisoning and support fouling by feedstock contaminants. Without being bound by theory, synthesizing the membrane phase to partially cover the electronically conductive support material may decrease the operating energy consumption of the GDE by maintaining electrochemically active surface area. Without being bound by theory, synthesizing the membrane phase to partially cover the electronically conductive support material may increase the purity of product streams. Without being bound by theory, the thickness of the membrane phase may be synthesized to tune porosity or selectivity for the reaction of interest.

### Ion-Conducting Phase

In an aspect, a GDE described herein comprises an ion-conducting phase. As used herein, an “ion-conducting phase” means any phase that allows movement of ions through the phase. In an aspect, an ion-conducting phase is a solid phase. In an aspect, an ion-conducting phase is a liquid phase. In an aspect, an ion-conducting phase is an amorphous phase.

As used herein, an “ionomer phase” is a solid or amorphous phase comprising repeating neutral and ionized monomer subunits bonded to a polymer backbone. In an aspect, the ionomer phase facilitates the movement of ions. In an aspect, an ion-conducting phase comprises an ionomer phase. In an aspect, an ion-conducting phase consists of an ionomer phase. In an aspect, an ion-conducting phase is an ionomer phase.

In an aspect, an ionomer phase is synthesized by applying a dissolved polymer via electrodeposition, dip coating, spray coating, or spin coating. In an aspect, an ionomer phase is synthesized by polymerizing monomer subunits via thermal, photochemical, or electrochemical techniques.

In an aspect, the ion-conducting phase is selective for the transport of one or more cations. In an aspect, cation includes, but is not limited to, H⁺. In an aspect, the ion-conducting phase is selective for the transport of one or more anions. In an aspect, anion includes, but is not limited to, OH⁻.

In an aspect, the ionomer phase comprises one or more ionomers. In an aspect, ionomers include, but are not limited to, sulfonated fluorocarbon polymers, sulfonated poly(ether ether ketone), sulfonated polystyrene, imidazolium-functionalized styrene, imidazolium-functionalized vinyl-benzene chloride, and phosphoric acid-doped polybenzimidazole. In an aspect, the ionomer is Nafion. In an aspect, the ionomer is Sustainion.

### Electronically Conductive Support Material

In an aspect, a GDE described herein comprises an electronically conductive support material. As used herein, a “support” is a material to which a catalyst is affixed. In an aspect, the support mechanically stabilizes the catalyst. In an aspect, the support is a powder. In an aspect, the support is a foil. In an aspect, the support is a foam. In an aspect, the support is porous. In an aspect, the support interacts with the catalyst in a support-catalyst interaction. In an aspect the support-catalyst interaction changes the catalytic properties of the catalyst. In an aspect, the support-catalyst interaction is a strong metal-support interaction. As used herein, a “electronically conductive” is defined as the property of a material to allow the flow of electrical current.

In an aspect, the electronically conductive support material comprises one or more compositionally distinct materials. In an aspect, electronically conductive support materials include, but are not limited to, nanostructured carbon, metals, and metal oxides, metal carbides, metal nitrides, MXenes, metal alloys, and metal composites. In an aspect, electronically conductive support materials is structured in the form of a sheet, weave, paper, cloth, foil, thin film, nanoparticle, felt, or foam. In an aspect, the electronically conductive support material is carbon paper.

In an aspect, nanostructured carbon, includes but is not limited to, graphene, graphite, carbon nanotubes (CNTs), carbon black, carbon cloth, carbon paper, carbon fiber, carbon felt, carbon spheres, and glassy carbon. In an aspect, metals include, but are not limited to, nickel (Ni), titanium (Ti), and aluminum (Al). In an aspect, metal oxides include, but are not limited to, TiO₂ and Al₂O₃. In an aspect, metal carbides include, but are not limited to, WC, W₂C, TiC, MoC, Mo₂C, TaC, VC, and NbC. In an aspect, metal carbides are transition metal carbides. In an aspect, metal nitrides include but are not limited to WN, W₂N, TiN, MoN, Mo₂N, TaN, VN, and NbN. In an aspect, metal nitrides are transition metal nitrides. In an aspect, metal alloys include but are not limited to stainless steel. In an aspect, metal composites include but are not limited to steel.

In an aspect, the support material is coated with a wetting agent. As used herein, a “wetting agent” is a chemical species or surface modification that alters the surface tension of a material. In an aspect, wetting agent includes, but is not limited to, fluorinated polymers, polyvinylidene fluoride (PVDF), polytetrafluoroethylene (PTFE), polyvinylchloride (PVC), fluorinated ethylene propylene (FEP), perfluoroalkoxy polymer resin (PFA), and polychlorotrifluoroethylene (PCTFE).

In an aspect, the support material is encapsulated in a membrane phase. In an aspect, the membrane phase is deposited onto the support material by a non-line-of-sight deposition method. In an aspect, the membrane phase is deposited onto the support material by atomic layer deposition (ALD). In an aspect, the membrane phase is deposited onto the support material by chemical vapor deposition (CVD). In an aspect, the membrane phase is deposited onto the support material by sol gel. In an aspect, the membrane phase is deposited onto the support material by physical vapor deposition (PVD). In an aspect, the membrane phase is deposited onto the support material by condensed layer deposition (CLD).

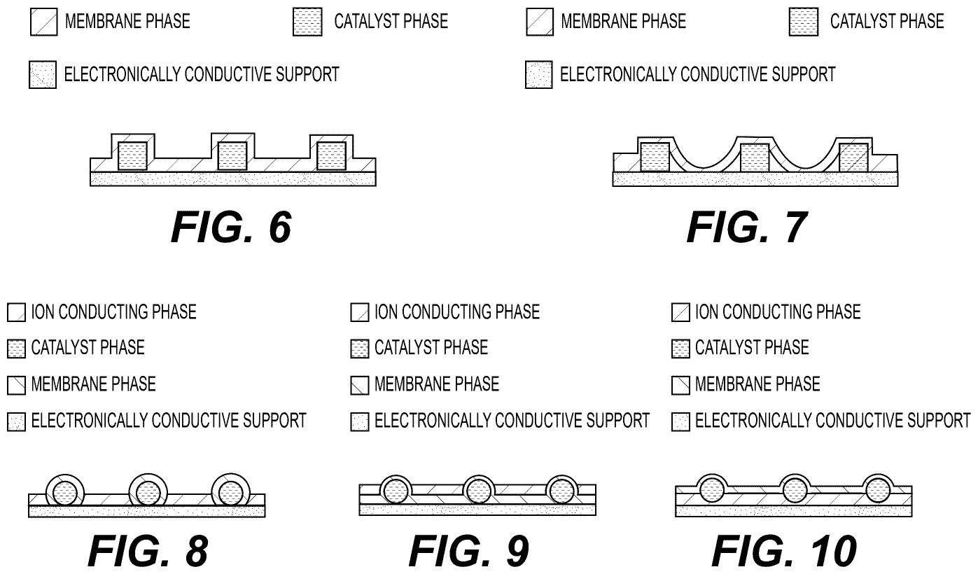

The membrane phase may be conformal to the underlying material and form a uniform coating. FIG. 6 shows an electrode where the membrane phase is conformal, and forms a continuous coating around all the phases. In an aspect, the membrane phase is conformal to the underlying material and continuous. The electrode may also have a membrane phase that forms as a non-conformal coating around all phases (FIG. 7). In an aspect, the membrane phase is non-continuous, and has variations in thickness across its surface. In an aspect, the support material is a porous film.

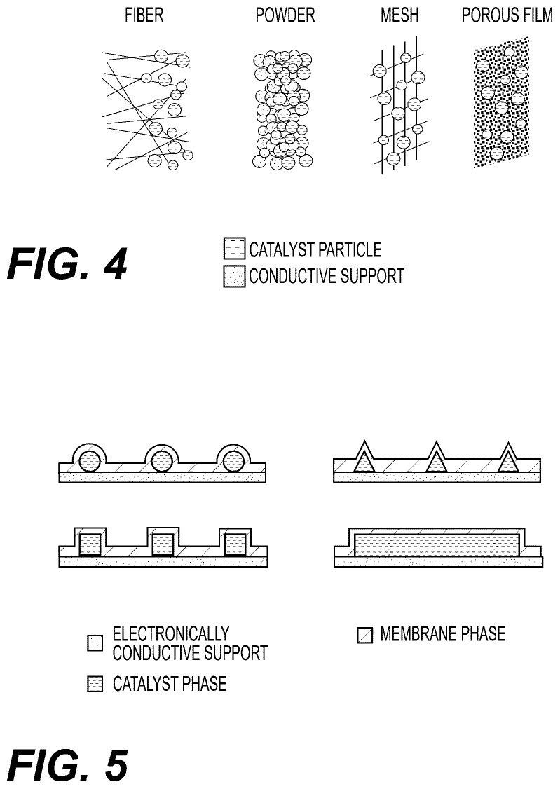

In an aspect, the support material is permeable to gases and liquids. In an aspect, the support material is channel-structured. In an aspect, the support material is pore-structured. In an aspect, the support material has a macroporous region. In an aspect, the support material has a mesoporous region. In an aspect, the support material has a microporous region. In an aspect, the support material has different geometries (FIG. 4). In an aspect, the support material is a fiber. In an aspect, the support material is a mesh. In an aspect, the support material is a powder.

### Catalytic Phase

In an aspect, a GDE described herein comprises a catalytic phase. As used herein, a “catalytic phase” is a phase of material that increases the rate of a chemical reaction without the material itself undergoing an irreversible chemical change, under specific reaction conditions. In an aspect, a catalytic phase comprises a catalyst. In an aspect, a catalytic phase comprises a catalyst affixed to a support material. In an aspect, a catalyst is an electrocatalyst that participates in electrochemical reactions. In an aspect, an electrochemical reaction is catalyzed at the surface of an electrocatalyst.

In an aspect, the catalytic phase is metallic, bimetallic, trimetallic, or alloyed. In an aspect the catalytic phase includes, but is not limited to, gold (Au), silver (Ag), copper (Cu), platinum (Pt), palladium (Pd), tin (Sn), lead (Pb), iridium (Ir), indium (In), bismuth (Bi), Au bimetals, Ag bimetals, Cu bimetals, Pt bimetals, Pd bimetals, Sn bimetals, Pb bimetals, Ir bimetals, In bimetals, Bi bimetals, Au alloys, Ag alloys, Cu alloys, Pt alloys, Pd alloys, Sn alloys, Pb alloys, Ir alloys, In alloys, and Bi alloys. In an aspect, the catalytic phase is oxidized.

As used herein, a catalytic phase has a “specific electrochemically active surface area,” which is the surface area per mass catalyst accessible to participate in an electrochemical reaction. In an aspect, the catalytic phase comprises a specific electrochemically active surface area in the range of about 0.1 to about 30 (m²/g). In an aspect, the catalytic phase loading is in the range of about 0.1 mg/cm² to about 10 mg/cm². In an aspect, the catalytic phase loading is in the range of about 0.1 mg/cm² to about 2 mg/cm². In an aspect, the catalytic phase loading is in the range of about 2 mg/cm² to about 8 mg/cm². In an aspect, the catalytic phase loading is in the range of about 8 mg/cm² to about 10 mg/cm².

In an aspect, the catalytic phase comprises catalyst nanoparticles. In an aspect, the nanoparticles have defined geometrical shapes (FIG. 5). Without being bound by theory, the shapes of catalyst nanoparticles affects reaction rates by determining how well reactants align for the chemical reaction. The compositions and methods herein may be used or applied to any shape of catalyst. In an aspect, the nanoparticles are spheres. In an aspect, the nanoparticles are cubes. In an aspect, the nanoparticles are triangles. In an aspect, the nanoparticles are tetrahedrons. In an aspect, the nanoparticles are octahedrons. In an aspect, the nanoparticles are decahedrons. In an aspect, the nanoparticles are icosahedrons. In an aspect, the nanoparticles are rods. In an aspect, the nanoparticles are wires. In an aspect, the nanoparticles are plates. In an aspect, the nanoparticles are discs. In an aspect, the nanoparticles are triangular plates. In an aspect, the nanoparticles are hexagonal-plates. In an aspect, the nanoparticles are bi-pyramids. In an aspect, the nanoparticles are tetrapods. In an aspect, the nanoparticles are hyper-branched structures. In an aspect, the nanoparticles are a film. In an aspect, the nanoparticles are a 2D film. In an aspect, the nanoparticles are a 3D film. In an aspect, the nanoparticles are a continuous film.

In an aspect, the catalytic phase comprises nanoparticles with an average diameter in the range of about 0.3 nm to about 500 nm. In an aspect, the catalytic phase comprises nanoparticles with an average diameter in the range of about 5 nm to about 300 nm. In an aspect, the catalytic phase comprises nanoparticles with an average diameter in the range of about 10 nm to about 200 nm. In an aspect, the catalytic phase comprises nanoparticles with an average diameter in the range of about 20 nm to about 100 nm. In an aspect, the catalytic phase comprises nanoparticles with an average diameter in the range of about 0.3 nm to about 250 nm. In an aspect, the catalytic phase comprises nanoparticles with an average diameter in the range of about 0.3 nm to about 100 nm. In an aspect, the catalytic phase comprises nanoparticles with an average diameter in the range of about 0.3 nm to about 50 nm. In an aspect, the catalytic phase comprises nanoparticles with an average diameter in the range of about 0.3 nm to about 5 nm. In an aspect, the catalytic phase comprises nanoparticles with an average diameter in the range of about 5 nm to about 15 nm. In an aspect, the catalytic phase comprises nanoparticles with an average diameter in the range of about 15 nm to about 50 nm. In an aspect, the catalytic phase comprises nanoparticles with an average diameter in the range of about 50 nm to about 150 nm. In an aspect, the catalytic phase comprises nanoparticles with an average diameter in the range of about 150 nm to about 250 nm. In an aspect, the catalytic phase comprises nanoparticles with an average diameter in the range of about 250 nm to about 500 nm.

In an aspect, the catalytic phase is adsorbed directly to the support material. In an aspect, the catalytic phase is adhered to the support with a polymer that includes but is not limited to fluoropolymers, proton-exchange ionomers or anion-exchange ionomers. In an aspect, the catalytic phase is chemically bonded to the support material. In an aspect, the catalytic phase is chemically bonded to the support material with an adhesive. In an aspect, the adhesive is electronically conductive. In an aspect, the adhesive includes, but is not limited to, metal-free electrically conductive adhesives (ECAs), silver-based ECAs, and tantalum-based ECAs.

The present disclosure provides a ME-GDE comprises an electronically conductive support material comprising nanostructured carbon, a catalytic phase comprising Ag, a membrane phase comprising SiO₂, and an ion-conducting phase comprising Nafion, wherein the membrane phase encapsulates the catalytic phase, and wherein the catalytic phase is embedded in the ion-conducting phase.

### EXAMPLES

The present disclosure is illustrated by the following examples. The examples set out herein illustrate several aspects of the present disclosure but should not be construed as limiting the scope of the present disclosure in any manner.

### EXAMPLE 1

### Membrane-Encapsulated Nanoparticle GDE

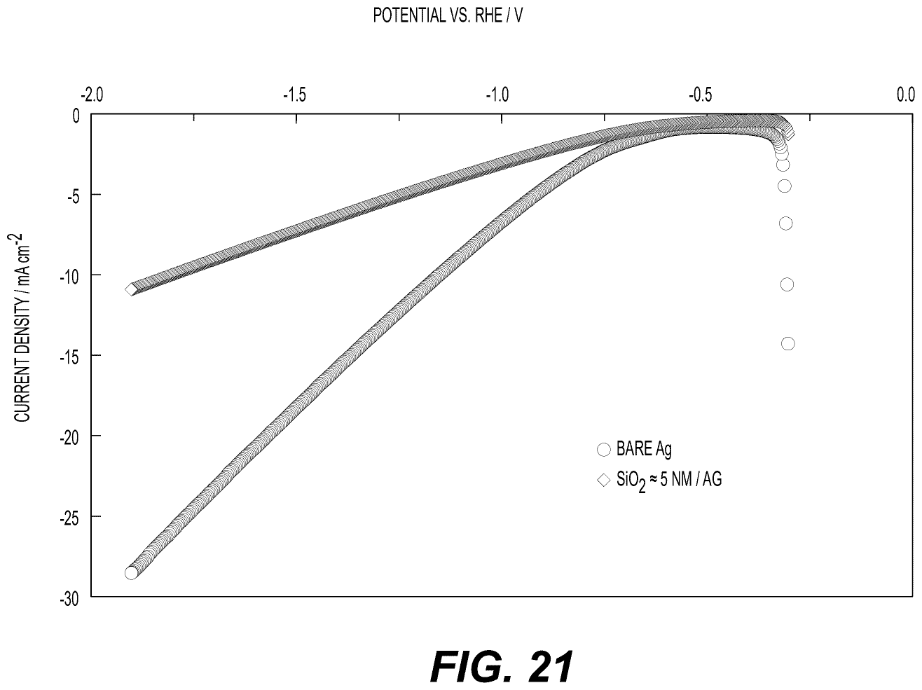

An exemplary membrane-embedded gas diffusion electrode (ME-GDE) as shown in FIG. 21 is synthesized. Briefly, the ME-GDE comprises a semi-permeable, species-selective membrane (4) in contact with the surface of catalyst nanoparticles (3), which are supported on carbon nanotubes (CNT). The CNT-supported, membrane-encapsulated catalyst nanoparticles are mixed into an ionomer slurry and deposited onto a porous, conductive support material (1).

### Preparing the Support Electrode

A porous, carbon support electrode made of woven carbon fiber with a porosity of 60-80%, and pore size of 20-100 μm, and 5% poly-tetraflouroethylene (Fuel Cell Store, 7302008) is rinsed with ethanol and DI water. The support is then dried at 60° C. for 1 hour to remove excess moisture from the porous carbon matrix.

### Constructing the Microporous Layer

A 0.05 g/mL dispersion of carbon black (Vulcan XC 72R, particle size 50 nm) in a 1:1 solution of ethyl alcohol and DI water with 0.01 g/mL surfactant (Triton-X or SDS) is deposited onto the surface of the organo-siloxane membrane composite via drop casting to create a microporous gas diffusion layer, which allows for continuous permeation of gases to the reactive catalyst layer, and ensures electrical conduction between the gas diffusion electrode and the catalyst layer. To adjust the wettability of the microporous layer, up to 5 wt % of PTFE is added to the drop casting mixture.

### Preparing the Catalyst/CNT Nanoparticles

About 500 mg of carbon nanotubes (CNT) (multi-walled, >98% carbon basis, 6-13 nm OD×2.5-20 μm L) are sonicated for 24 hours in 1 L of an aqueous solution of 1 wt % SDS until fully dispersed. A second solution of 80 mM silver nitrate (AgNO₃) in DI water is prepared and sonicated for 10 minutes. The silver nitrate solution is then added slowly to the CNT solution under vigorous stirring, followed by a slow addition (<1 mL/min) of aqueous 600 mM sodium tetrahydridoborate (NaBH₄) to reduce the silver nitrate into solid silver (Ag⁰) on the CNT surface. The Ag/CNT solution slurry is stirred for 12-18 hours, depending on the desired size of the final Ag nanoparticles. The silver nitrate reduction reaction is terminated by filtering the Ag/CNT particles from solution via vacuum filtration, with multiple rinses with DI water. The Ag/CNT particles are then mixed into a solution of DI water to remove residual precursor, centrifuged at low rotary speeds, filtered from solution, and dried overnight under vacuum at 60° C.

### Encapsulating the Catalyst Nanoparticles in a Membrane Phase

10 mg of CNT-supported Ag catalyst are mixed into 7.5 mL of ethanol. Roughly 2.3-2.5 mL of DI water and 0.18-0.2 mL of 28% aqueous ammonia (NH3) is added to the mixture, and ultrasonicated for 15 minutes. A solution of 1.2-3.5 mg/mL of PDMS and 0-5.2 mg/mL tetra-ethoxy silane (TEOS) is dissolved into ethanol, and added drop-wise to the catalyst dispersion under sonication. The mixture is then continuously stirred for 1-3 hours, depending on the desired thickness of the SiO₂ shell (2-20 nm) before the encapsulated catalyst slurry is separated from solution and washed repeatedly with DI water. The encapsulated nanoparticles are then dried under vacuum for 2 hours to remove excess moisture.

### Depositing the Catalyst Mixture onto the Electrode

The encapsulated nanoparticles are mixed into an Nafion ionomer solution (5% Nafion, in 1:1 water and ethanol) via ultrasonication to achieve a uniform slurry. The catalyst slurry is then spray-coated onto the microporous carbon layer on the electrode support until a semi-continuous layer 40-800 nm thick, or no less than 0.1 mg/cm², catalyst loading is achieved. The entire electrode is then dried by flowing nitrogen gas (>98% N₂) through the porous electrode assembly to ensure all residual solvet is evaporated.

### EXAMPLE 2

### Membrane-Encapsulated Ionomer Phase GDE

An exemplary ME-GDE as shown in FIG. 10 is synthesized. Briefly, the ME-GDE comprises a semi-permeable, species-selective membrane (4) in direct contact with the surface boundary of an ionomer phase (2). Catalyst nanoparticles (3), which are supported on CNT, are embedded within the ionomer phase (2) and do not make direct contact with the membrane (4). Preparing the Support Electrode

A porous, carbon support electrode made of woven carbon fiber with a porosity of 60-80%, and pore size of 20-100 μm, and 5% poly-tetraflouroethylene (Fuel Cell Store, 7302008) is rinsed with ethanol and DI water. The support is then dried at 60° C. for 1 hour to remove excess moisture from the porous carbon matrix.

### Constructing the Microporous Layer

A 0.05 g/mL dispersion of carbon black (Vulcan XC 72R, particle size 50 nm) in a 1:1 solution of ethyl alcohol and DI water with 0.01 g/mL surfactant Triton-X or SDS) is deposited onto the surface of the organo-siloxane membrane composite via drop casting to create a microporous gas diffusion layer, which allows for continuous permeation of gases to the reactive catalyst layer, and ensures electrical conduction between the gas diffusion electrode and the catalyst layer. To adjust the wettability of the microporous layer, up to 5 wt % of PTFE is added to the drop casting mixture.

### Preparing the Catalyst/CNT Nanoparticles

About 500 mg of CNT (multi-walled, >98% carbon basis, 6-13 nm OD×2.5-20 μm L) are sonicated for 24 hours in 1 L of an aqueous solution of 1 wt % SDS until fully dispersed. A second solution of 80 mM silver nitrate (AgNO₃) in DI water is prepared and sonicated for 10 minutes. The silver nitrate solution is then added slowly to the CNT solution under vigorous stirring, followed by a slow addition (<1 mL/min) of aqueous 600 mM sodium tetrahydridoborate (NaBH₄) to reduce the silver nitrate into solid silver (Ag⁰) on the CNT surface. The Ag/CNT solution slurry is stirred for 12-18 hours, depending on the desired size of the final Ag nanoparticles. The silver nitrate reduction reaction is terminated by filtering the Ag/CNT particles from solution via vacuum filtration, with multiple rinses with DI water. The Ag/CNT particles are then mixed into a solution of DI water to remove residual precursor, centrifuged at low rotary speeds, filtered from solution, and dried overnight under vacuum at 60° C.

### Depositing the Catalyst Mixture Onto the Electrode

The nanoparticles are mixed into an Nafion ionomer solution (5% Nafion, in 1:1 water and ethanol) via ultrasonication to achieve a uniform slurry. The catalyst slurry is then spray-coated onto the microporous carbon layer on the electrode support until a semi-continuous layer 40-800 nm thick, or no less than 0.1 mg/cm², catalyst loading is achieved. The entire electrode is then dried by flowing nitrogen gas (>98% N2) through the porous electrode assembly to ensure all residual solvent is evaporated.

### Encapsulating the Ionomer Phase

The catalyst-embedded ionomer phase is then encapsulated in a semi-permeable, 10 nm silicon dioxide (SiO₂) layer. Specifically, a SiO₂ layer is deposited via a sol-gel method, through non-line-of-sight physical vapor deposition, or by atomic layer deposition (ALD).

### EXAMPLE 3

### Membrane-Encapsulated Ionomer Phase GDE

An exemplary ME-GDE as shown in FIG. 10 is synthesized. Briefly, the ME-GDE comprises a semi-permeable, species-selective membrane (4) in direct contact with the surface boundary of an ionomer phase (2). Catalyst nanoparticles (3), which are supported on CNT, are embedded within the ionomer phase (2) and do not make direct contact with the membrane (4).

### Depositing the Catalyst Mixture Onto the Electrode

Ag nanoparticles are mixed into a 1:1 water: ethanol mixture containing Sustainion XA-9 ionomer solution via ultrasonication to achieve a uniform slurry. The catalyst slurry is then spray-coated onto a Sigracet 39BB carbon paper substrate containing a microporous layer. The entire electrode is then dried under vacuum.

### Encapsulating the Ionomer Phase

The catalyst-embedded ionomer phase is then encapsulated in a semi-permeable, 10 nm silicon dioxide (SiO₂) layer via a sol-gel method. Specifically, a solution of ammonium hydroxide in distilled water (1 mL NH₄OH in 12.5 mL H₂O) is added dropwise to a beaker containing ethanol (37.5 mL). The electrode is positioned in the beaker above the liquid level. Then, a solution containing tetraethoxysilane (TEOS) (1.24 mL) in ethanol (223 mL) is added to the beaker dropwise. The electrode is positioned such that the active area is completely covered by the solution when the TEOS addition is complete. After the addition is complete, the solution is allowed to stir until the desired thickness of SiO₂ is achieved (1-5 hours). The final ME-GDE is dried under vacuum prior to use.

### EXAMPLE 4

### Membrane-Phase Embedded GDE

An exemplary ME-GDE as shown in FIG. 14 is synthesized. Briefly, the ME-GDE comprises a semi-permeable, species-selective membrane (4) applied in a homogeneous layer that is interspersed within the macroporous, mesoporous, and microporous regions of the gas diffusion layer of a conductive support material (1). Further embedded within the conductive support material (1) are catalyst nanoparticles (3), which are supported on CNT and embedded within an ionomer phase (2). Neither the ionomer phase (2) nor the CNT-supported catalyst nanoparticles (3) within the ionomer phase are in direct contact with the membrane (4).

### Preparing the Support Electrode

A porous, carbon support electrode made of woven carbon fiber with a porosity of 60-80%, and pore size of 20-100 μm, and 5% poly-tetraflouroethylene (Fuel Cell Store, 7302008) is rinsed with ethanol and DI water. The support is then dried at 60° C. for 1 hour to remove excess moisture from the porous carbon matrix.

### Adhering the Exterior Support Membrane

A solution of 1.1-10.4 mg/mL PDMS in toluene is prepared and deposited onto the surface of the woven carbon fiber support by spray-coating the mixture in a single layer. The PDMS layer is then dried under vacuum at 90° C. for 1 hr. The spray coating and drying process is repeated until a continuous, hole-free PDMS membrane completely coated the surface of the carbon weave. The membrane layer is then cured into an organo-siloxane composite (SiOₓC_{y}, y=1−2) by curing the electrode in a UV-Ozone chamber, in which an air-rich environment is exposed to UV light to generate reactive ozone and oxygen radicals, for 30-120 minutes depending on the desired degree of curing or residual carbon concentration. To prevent the degradation of the carbon support during the UV ozone conversion process, the un-coated portions of the carbon weave are dipped and submerged in DI water. The exterior support membrane may also be added using a Langmuir-Blodgett application technique.

### Constructing the Microporous Layer

A 0.05 g/mL dispersion of carbon black (Vulcan XC 72R, particle size 50 nm) in a 1:1 solution of ethyl alcohol and DI water with 0.01 g/mL surfactant (Triton-X or SDS) is deposited onto the surface of the organo-siloxane membrane composite via drop casting to create a microporous gas diffusion layer, which allows for continuous permeation of gases to the reactive catalyst layer, and ensures electrical conduction between the gas diffusion electrode and the catalyst layer. To adjust the wettability of the microporous layer, up to 5 wt % of PTFE is added to the drop casting mixture.

### Preparing the Catalyst/CNT Nanoparticles

About 500 mg of carbon nanotubes (CNT) (multi-walled, >98% carbon basis, 6-13 nm OD×2.5-20 μm L) are sonicated for 24 hours in 1 L of an aqueous solution of 1 wt % SDS until fully dispersed. A second solution of 80 mM silver nitrate (AgNO₃) in DI water is prepared and sonicated for 10 minutes. The silver nitrate solution is then added slowly to the CNT solution under vigorous stirring, followed by a slow addition (<1 mL/min) of aqueous 600 mM sodium tetrahydridoborate (NaBH₄) to reduce the silver nitrate into solid silver (Ag⁰) on the CNT surface. The Ag/CNT solution slurry is stirred for 12-18 hours, depending on the desired size of the final Ag nanoparticles. The silver nitrate reduction reaction is terminated by filtering the Ag/CNT particles from solution via vacuum filtration, with multiple rinses with DI water. The Ag/CNT particles are then mixed into a solution of DI water to remove residual precursor, centrifuged at low rotary speeds, filtered from solution, and dried overnight under vacuum at 60° C.

### Depositing the Catalyst Mixture onto the Electrode

The nanoparticles are mixed into an Nafion ionomer solution (5% Nafion, in 1:1 water and ethanol) via ultrasonication to achieve a uniform slurry. The catalyst slurry is then spray-coated onto the microporous carbon layer on the electrode support until a semi-continuous layer 40-800 nm thick, or no less than 0.1 mg/cm², catalyst loading is achieved. The entire electrode is then dried by flowing nitrogen gas (>98% N₂) through the porous electrode assembly to ensure all residual solvent is evaporated.

### EXAMPLE 5

### Membrane-Encapsulated Conductive Support Material GDE

An exemplary ME-GDE as shown in FIG. 14 is synthesized. Briefly, the ME-GDE comprises a semi-permeable, species-selective membrane (4) applied to the exterior surface of the diffusion layer as an uninterrupted, homogenous membrane layer that is distinct from a conductive support material (1) and all other regions of the GDE. Further embedded within the conductive support material (1) is an ionomer phase wherein catalyst nanoparticles (3), which are supported on CNT, are adhered. Neither the ionomer phase (2) nor the CNT-supported catalyst nanoparticles (3) within the ionomer phase are in direct contact with the membrane (4).

### Preparing the Support Electrode

A porous, carbon support electrode made of woven carbon fiber with a porosity of 60-80%, and pore size of 20-100 μm, and 5% poly-tetraflouroethylene (Fuel Cell Store, 7302008) is rinsed with ethanol and DI water. The support is then dried at 60° C. for 1 hour to remove excess moisture from the porous carbon matrix.

### Constructing the Microporous Layer

A 0.05 g/mL dispersion of carbon black (Vulcan XC 72R, particle size 50 nm) in a 1:1 solution of ethyl alcohol and DI water with 0.01 g/mL surfactant (Triton-X or SDS) is deposited onto the surface of the organo-siloxane membrane composite via drop casting to create a microporous gas diffusion layer, which allows for continuous permeation of gases to the reactive catalyst layer, and ensures electrical conduction between the gas diffusion electrode and the catalyst layer. To adjust the wettability of the microporous layer, up to 5 wt % of PTFE is added to the drop casting mixture.

### Preparing the Catalyst/CNT Nanoparticles

Roughly 500 mg of CNT (multi-walled, >98% carbon basis, 6-13 nm OD×2.5-20 μm L) are sonicated for 24 hours in 1 L of an aqueous solution of 1 wt % SDS until fully dispersed. A second solution of 80 mM silver nitrate (AgNO₃) in DI water is prepared and sonicated for 10 minutes. The silver nitrate solution is then added slowly to the CNT solution under vigorous stirring, followed by a slow addition (<1 mL/min) of aqueous 600 mM sodium tetrahydridoborate (NaBH₄) to reduce the silver nitrate into solid silver (Ag⁰) on the CNT surface. The Ag/CNT solution slurry is stirred for 12-18 hours, depending on the desired size of the final Ag nanoparticles. The silver nitrate reduction reaction is terminated by filtering the Ag/CNT particles from solution via vacuum filtration, with multiple rinses with DI water. The Ag/CNT particles are then mixed into a solution of DI water to remove residual precursor, centrifuged at low rotary speeds, filtered from solution, and dried overnight under vacuum at 60° C.

### Depositing the Catalyst Mixture Onto the Electrode

The nanoparticles are mixed into an Nafion ionomer solution (5% Nafion, in 1:1 water and ethanol) via ultrasonication to achieve a uniform slurry. The catalyst slurry is then spray-coated onto the microporous carbon layer on the electrode support until a semi-continuous layer 40-800 nm thick, or no less than 0.1 mg/cm², catalyst loading is achieved. The entire electrode is then dried by flowing nitrogen gas (>98% N₂) through the porous electrode assembly to ensure all residual solvent is evaporated.

### Encapsulating the Conductive Support Material in a Membrane Phase

A homogenous, semi-permeable, 2-20 nm silicon dioxide (SiO₂) membrane phase is then deposited to the exterior surface of the diffusion layer as an uninterrupted, homogenous membrane layer that is distinct from the conductive support material (1) and all other regions of the GDE. Specifically, the SiO₂ layer is deposited via a sol-gel method or through a line-of-sight physical vapor deposition.

### Adhering the Exterior Support Membrane

A solution of 1.1-10.4 mg/mL PDMS in toluene is prepared and deposited onto the surface of the woven carbon fiber support by spray-coating the mixture in a single layer. The PDMS layer is then dried under vacuum at 90° C. for 1 hr. The spray coating and drying process is repeated until a continuous, hole-free PDMS membrane completely coated the surface of the carbon weave. The membrane layer is then cured into an organo-siloxane composite (SiOₓC_{y}, y=1−2) by curing the electrode in a UV-Ozone chamber, in which an air-rich environment is exposed to UV light to generate reactive ozone and oxygen radicals, for 30-120 minutes depending on the desired degree of curing or residual carbon concentration. To prevent the degradation of the carbon support during the UV ozone conversion process, the un-coated portions of the carbon weave are dipped and submerged in DI water.

### EXAMPLE 6

### Ionomer-Free Nanoparticle Deposition Onto the Support

An exemplary ME-GDE as shown in FIG. 15 is synthesized. Ag nanoparticles supported on Vulcan XC72 (20 wt %) 313 mg are dispersed in 14.8 mL isopropanol. The catalyst ink is sonicated for 45 min then immediately spray coated onto a gas diffusion electrode with a microporous layer (Sigracet 39 BB). The spray coating proceeds until the desired catalyst loading has been achieved. The silver-coated electrode is dried under vacuum overnight.

### Membrane-Phase Encapsulation

The catalyst is then encapsulated in a semi-permeable, 10 nm silicon dioxide (SiO₂) layer via a sol-gel method. Specifically, a solution of ammonium hydroxide in distilled water (1 mL NH₄OH in 12.5 mL H₂O) is added dropwise to a beaker containing ethanol (37.5 mL). The electrode is positioned in the beaker above the liquid level. Then, a solution containing tetraethoxysilane (TEOS) (1.24 mL) in ethanol (223 mL) is added to the beaker dropwise. The electrode is positioned such that the active area is completely covered by the solution when the TEOS addition is complete. After the addition is complete, the solution is allowed to stir until the desired thickness of SiO₂ is achieved (1-5 hours). The final ME-GDE is dried under vacuum prior to use.

### Ionomer-Phase Deposition

The ionomer-phase is deposited by spray coating. 100 μL Nafion ionomer (5 wt %) is dispersed in 10 mL of a 1:1 water: ethanol mixture, sonicated for 30 min, then the mixture is immediately spray coated onto the membrane encapsulated Ag-coated GDE until the desired ratio of Ag/ionomer is achieved.

### EXAMPLE 7

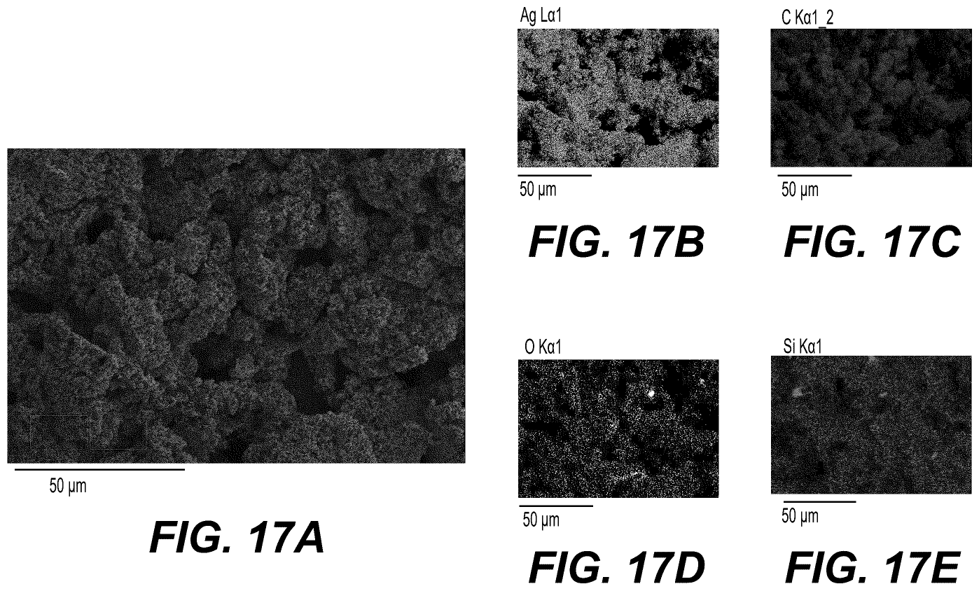

Encapsulated Ag nanoparticles supported on carbon synthesized using a sol-gel method described in Example 3 is visualized by Scanning Electron Microscopy (SEM) with Energy Dispersive X-ray Spectroscopy (EDS), as shown by FIGS. 17A-E. FIG. 17A shows the composite image of the different elements. The elemental distribution of Ag (FIG. 17B), carbon (FIG. 17C), oxygen (FIG. 17D), and silicon (FIG. 17E) show homogeneous SiO₂ encapsulation.

### EXAMPLE 8

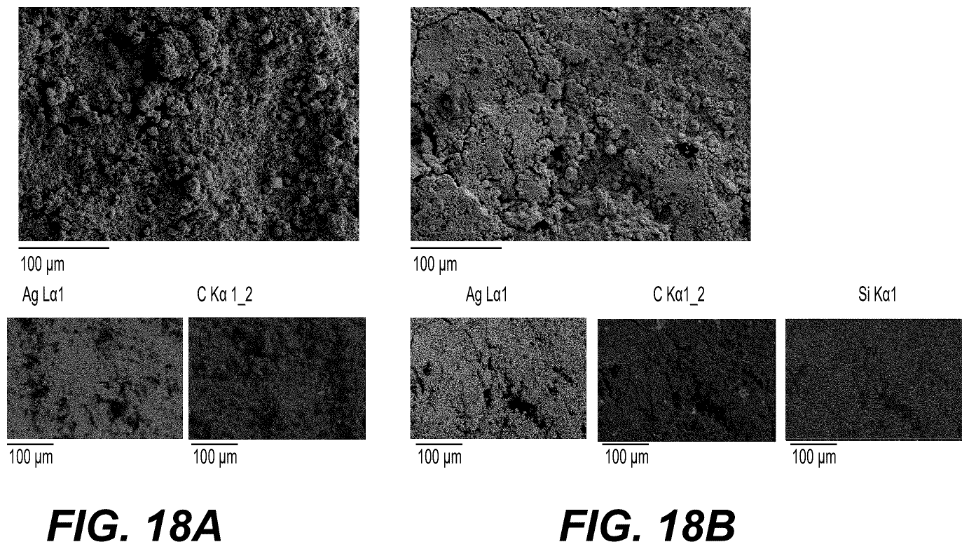

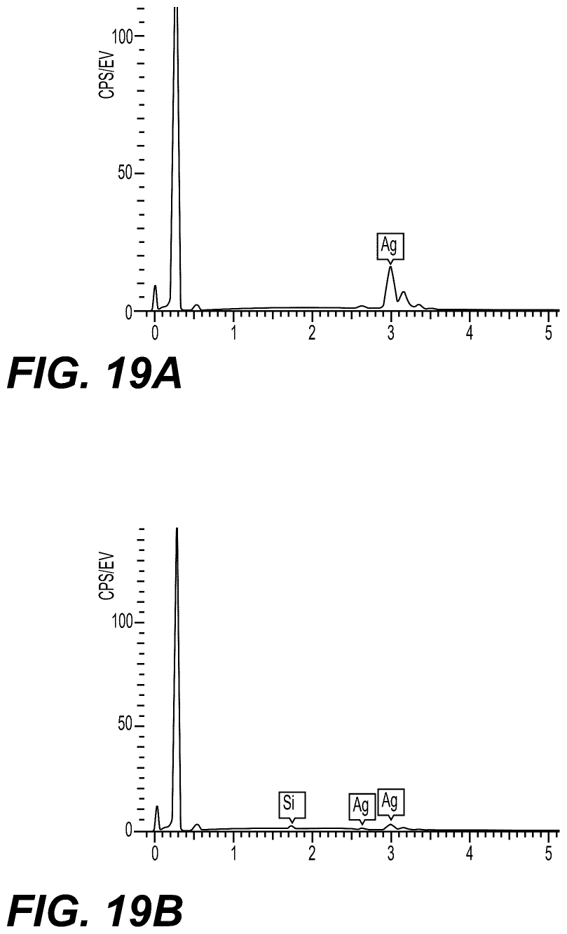

Encapsulated Ag nanoparticles supported on carbon paper substrate and encapsulated in a semi-permeable silicon dioxide (SiO₂) layer synthesized using a sol-gel method described in Example 3, is visualized by Scanning Electron Microscopy (SEM) with Energy Dispersive X-ray Spectroscopy (EDS), as shown by FIGS. 18A-B. FIG. 18A shows the composite of silver, carbon, and SEM images of Ag nanoparticles embedded in the ionomer on the carbon paper. FIG. 18B shows the composite of Ag, carbon, and SEM images of the Ag nanoparticles embedded in the ionomer on the carbon paper after encapsulation in SiO₂. FIGS. 19A-B depicts the EDS spectra showing the elemental analysis before (FIG. 19A) and after (FIG. 19B) encapsulation in SiO₂.

### EXAMPLE 9

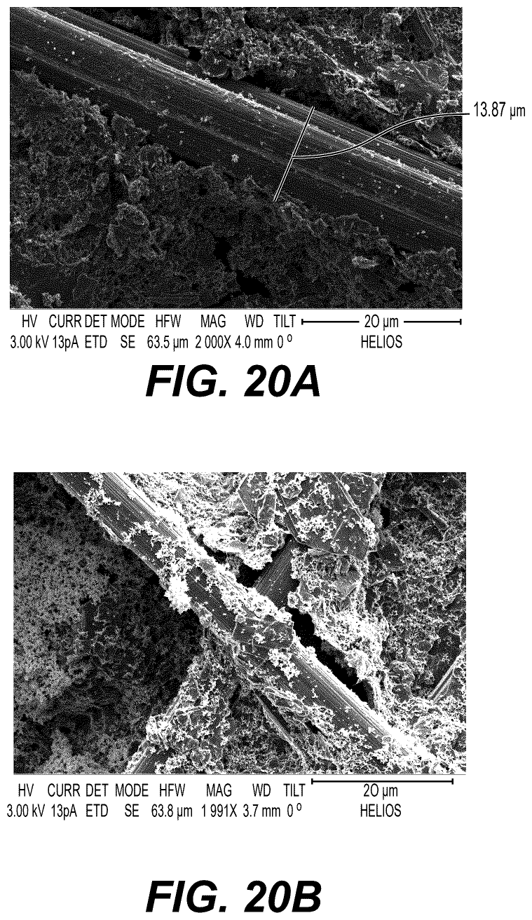

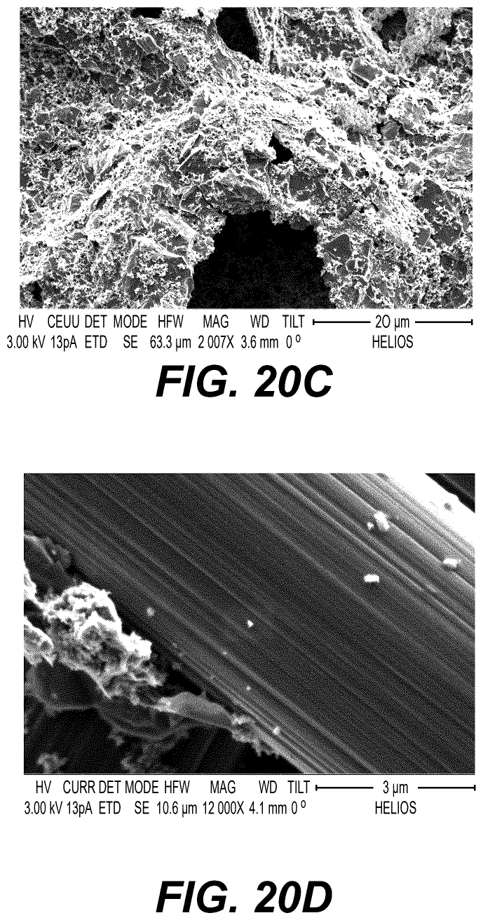

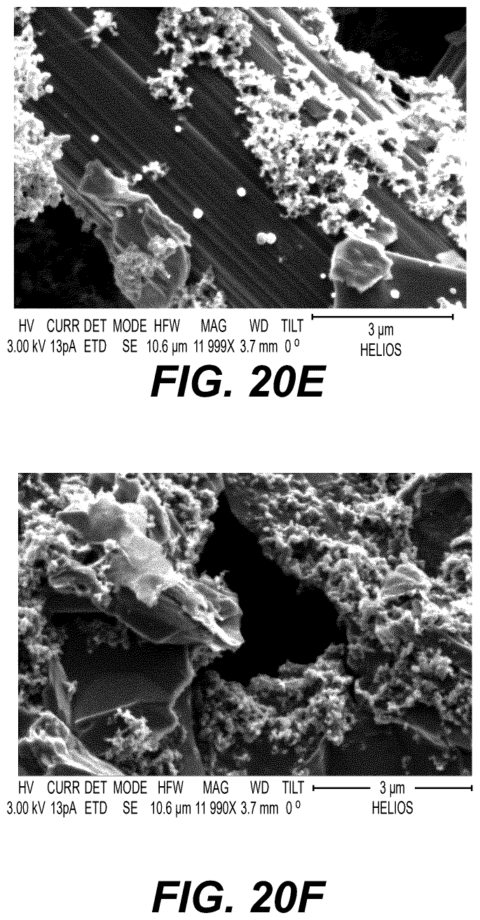

Encapsulated Ag nanoparticles supported on carbon paper substrate, encapsulated in a semi-permeable silicon dioxide (SiO₂) layer synthesized using a sol-gel method, and described in Example 6, is visualized by Scanning Electron Microscopy (SEM), as shown by FIGS. 20A-F. The morphological differences of the structures after each step of production is shown in FIGS. 20A-C (zoomed out), and FIGS. 20D-F (zoomed in). FIGS. 20A and 20D depict the structure of the bare carbon paper before coating. FIGS. 20B and 20E depict the structure of Ag deposited on carbon paper. FIGS. 20C and 20F depict Ag on deposited on carbon after encapsulation in SiO₂ using the sol gel method. As can be seen, the carbon fibers of the paper are no longer visible after SiO₂ encapsulation

### EXAMPLE 10

The activity, stability, and impurity tolerance, of the CNT-supported, SiO₂-membrane encapsulated Ag nanoparticles of Example 1 is assessed for the catalysis of the CO₂ electroreduction reaction (CO₂RR) in a setup independent of the membrane embedded GDE architecture. Specifically, the CNT-supported, SiO₂-membrane encapsulated Ag nanoparticles of Example 1, are sonicated in an ionomer slurry and spray-coat deposited onto a planar glassy carbon electrode coated with the microporous activated carbon layer solution of Example 1. Using a standard H-cell configuration for electrochemical testing, comprising a carbon rod counter electrode and Ag/AgCl reference electrode fixed in a secondary compartment, the experimental working electrode is tested in a CO₂-saturated 0.5 M KHCO₃ solution to measure activity, stability, and impurity tolerance, for the catalysis of CO₂RR in comparison to an unencapsulated Ag control electrode. The thickness of the SiO₂-membrane phase is tuned from 2 nm to 20 nm to assess the effect of membrane phase thickness on the suppression of competing electrochemical reactions to CO₂RR.

### EXAMPLE 11

The activity, stability, and impurity tolerance, of the ME-GDEs described in Examples 1-6 above are assessed in a H-type electrochemical cell. The H-type configuration comprises a carbon rod counter electrode and Ag/AgCl reference electrode fixed in a secondary compartment. The ME-GDEs are tested in a CO₂-saturated 0.5 M KHCO₃ solution to measure their activity, stability, and impurity tolerance, for the catalysis of CO₂RR, in comparison to an unencapsulated Ag control electrode. The thickness of the SiO₂-membrane or TiO₂-membrane phase is tuned to assess the effect of membrane phase thickness on the suppression of competing electrochemical reactions to CO₂RR. Product characterization is performed via gas chromatography.

FIG. 21 shows a linear sweep voltammogram of Ag with Sustainion ionomer on carbon paper before and after SiO₂ encapsulation, prepared using the method of Example 3. The measurement was performed in CO₂-saturated 0.5 M KHCO₃ at 20 m V/s.

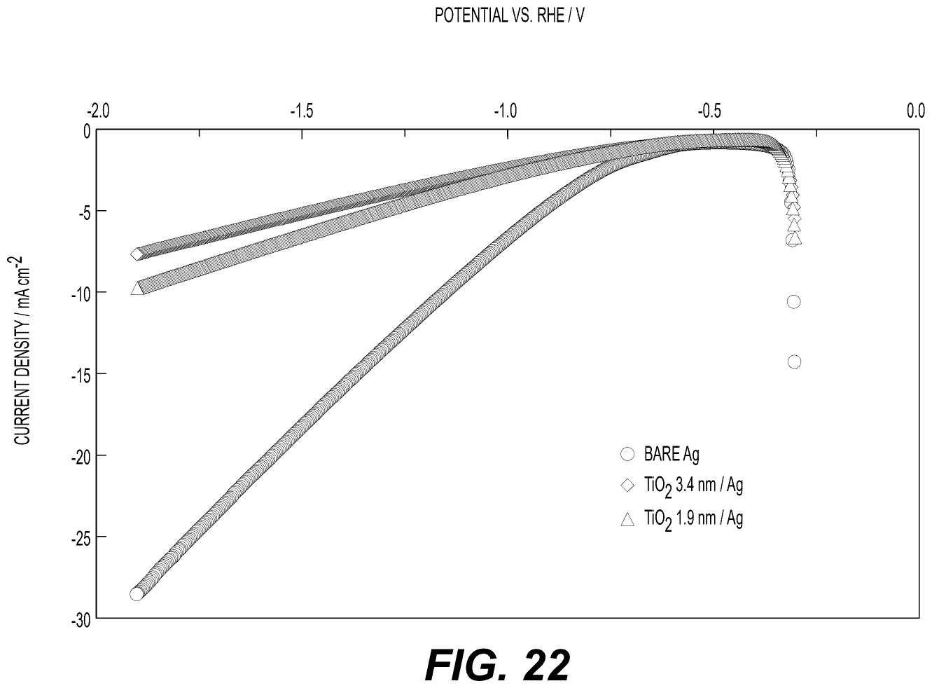

FIG. 22 shows a linear sweep voltammogram of Ag with Sustainion ionomer on carbon paper before and after TiO₂ encapsulation, prepared using the method of Example 6. The measurement was performed in CO₂-saturated 0.5 M KHCO₃ at 20 m V/s.

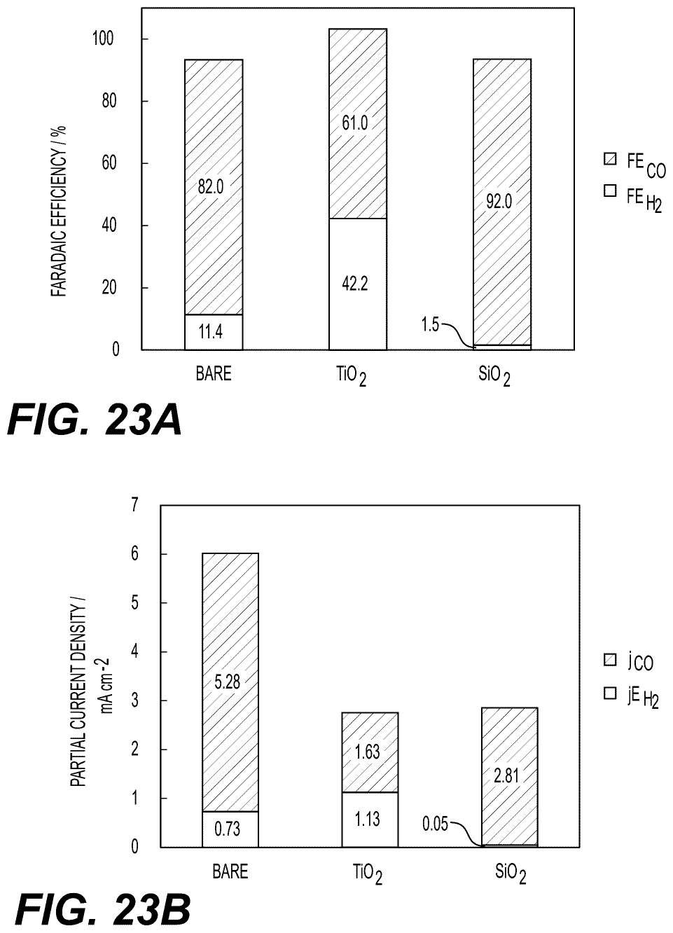

Changes in the selectivity for ME-GDEs fabricated under different conditions are shown in FIG. 23A-B. In FIG. 23A, the Faradaic efficiency for carbon monoxide production (FECO) and hydrogen production (FEH₂) are compared for Ag supported on carbon paper that is unencapsulated (bare), encapsulated in TiO₂, or SiO₂. In FIG. 23B, the partial current densities are compared. Experiments were performed at −1V vs. a reversible hydrogen electrode (RHE).

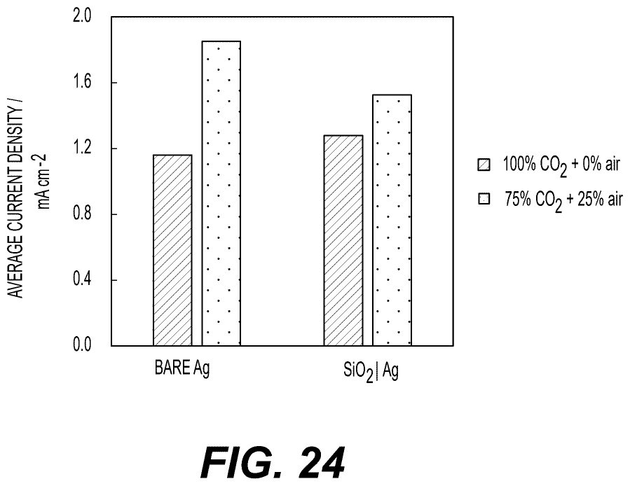

The electrochemical performance of SiO₂ encapsulated Ag in the presence of pure CO₂ vs. a CO₂/air mixture is depicted in FIG. 24, showing the selective permeability of the ME-GDE for CO₂ over O₂. An increase in current density at −1 V vs. RHE upon introduction of air is due to the competitive oxygen reduction reaction, which is suppressed by SiO₂.

### EMBODIMENTS

From the foregoing, it will be appreciated that the present invention can be embodied in various ways, which include but are not limited to the following:

Embodiment 1. A membrane-embedded gas diffusion electrode (ME-GDE), comprising: an electronically conductive support material; a catalytic phase; a membrane phase; and an ion-conducting phase; wherein the catalytic phase is dispersed in the ion-conducting phase, and wherein the ion-conducting phase is in contact with the electronically conductive support material.

Embodiment 2. The ME-GDE of embodiment 1, wherein the membrane phase comprises one or more oxides selected from the group consisting of MgO, MgO₂, MnO, MnO₂, SiO, SiO₂, CeO₂, TiO₂, SnO₂, Al₂O₃, and ZrO₂.

Embodiment 3. The ME-GDE of embodiment 1, wherein the membrane phase comprises one or more organic polymers selected from the group consisting of poly-dimethyl-siloxane (PDMS), organo-siloxane composites, sodium dodecyl sulfate (SDS), poly-tetrafluoroethylene, tetra-ethoxy silane (TEOS), cellulose acetates, polyamides, polyimides, and polysulfones.

Embodiment 4. The ME-GDE of any one of embodiments 1 to 3, wherein the membrane phase comprises two or more distinct layers.

Embodiment 5. The ME-GDE of any one of embodiments 1 to 4, wherein the membrane phase comprises a first layer comprising one or more oxides selected from the group consisting of MgO, MgO₂, MnO, MnO₂, SiO, SiO₂, CeO₂, TiO₂, SnO₂, Al₂O₃, and ZrO₂; and a second layer comprising one or more functionalized organic polymers selected from the group consisting of poly-dimethyl-siloxane (PDMS), organo-siloxane composites, sodium dodecyl sulfate (SDS), poly-tetrafluoroethylene, tetra-ethoxy silane (TEOS), cellulose acetates, polyamides, polyimides, and polysulfones.

Embodiment 6. The ME-GDE of any one of embodiments 1 to 5, wherein the membrane phase is permeable to one or more ions selected from the group consisting of H⁺, OH⁻, CO₂H⁻, and CO₃²⁻.

Embodiment 7. The ME-GDE of any one of embodiments 1 to 6, wherein the membrane phase is permeable to one or more molecules selected from the group consisting of CO, CO₂, H₂O, and C₁-C₄ alcohols.

Embodiment 8. The ME-GDE of any one of embodiments 1 to 7, wherein the membrane phase is impermeable to one or more molecules selected from the group consisting of NO, O₂, C₂-C₆ alkanes, C₁-C₆ alkenes, and C₁-C₆ alkynes.

Embodiment 9. The ME-GDE of any one of embodiments 1 to 8, wherein the membrane is impermeable to one or more ions selected from the group consisting of S²⁻, SO₃²⁻, SO₄²⁻, NO₂⁻, NO₃⁻, PO₄³⁻, PO₃H²⁻, F⁻, Cl⁻, Br⁻, and I⁻.

Embodiment 10. The ME-GDE of any one of embodiments 1 to 9, wherein the membrane phase is impermeable to one or more heavy metals.

Embodiment 11. The ME-GDE of any one of embodiments 1 to 10, wherein the membrane phase is impermeable to one or more heavy metal ions.

Embodiment 12. The ME-GDE of any one of embodiments 1 to 11, wherein the surface of the membrane phase is modified with one or more functional groups selected from the group consisting of imidazoles, amines, and amides.

Embodiment 13. The ME-GDE of any one of embodiments 1 to 12, wherein the membrane phase covers part of the catalytic phase.

Embodiment 14. The ME-GDE of any one of embodiments 1 to 12, wherein the membrane phase encapsulates the catalytic phase.

Embodiment 15. The ME-GDE of any one of embodiments 1 to 14, wherein the membrane phase is in direct contact with the ion-conducting phase.

Embodiment 16. The ME-GDE of any one of embodiments 1 to 12, wherein the membrane phase covers part of the ion-conducting phase.

Embodiment 17. The ME-GDE of any one of embodiments 1 to 12, wherein the membrane phase encapsulates the ion-conducting phase.

Embodiment 18. The ME-GDE of any one of embodiments 1 to 12, wherein the membrane phase is interspersed in the electronically conductive support material and is not in direct contact with the ion-conducting phase.

Embodiment 19. The ME-GDE of any one of embodiments 1 to 12, wherein the membrane phase partially encapsulates the electronically conductive support material.

Embodiment 20. The ME-GDE of any one of embodiments 1 to 19, wherein the ion-conducting phase is selective for the transport of one or more cations.

Embodiment 21. The ME-GDE of embodiment 20, wherein the cation is H⁻.

Embodiment 22. The ME-GDE of any one of embodiments 1 to 19, wherein the ion-conducting phase is selective for the transport of one or more anions.

Embodiment 23. The ME-GDE of embodiment 22, wherein the anion is OH⁻.

Embodiment 24. The ME-GDE of any one of embodiments 1 to 23, wherein the ion-conducting phase comprises one or more ionomers selected from the group consisting of sulfonated fluorocarbon polymers, sulfonated poly(ether ether ketone), sulfonated polystyrene, imidazolium-functionalized styrene, imidazolium-functionalized vinyl-benzene chloride, and phosphoric acid-doped polybenzimidazole.

Embodiment 25. The ME-GDE of any one of embodiments 1 to 24, wherein the ion-conducting phase is an ionomer.

Embodiment 26. The ME-GDE of any one of embodiments 1 to 25, wherein the support material comprises one or more materials selected from the group consisting of nanostructured carbon, metals, and metal oxides, metal carbides, metal nitrides, MXenes, metal alloys, and metal composites.

Embodiment 27. The ME-GDE of embodiment 26, wherein the nanostructured carbon is selected from the group consisting of graphene, graphite, carbon nanotubes (CNTs), carbon black, carbon cloth, carbon paper, carbon fiber, carbon felt, carbon spheres, and glassy carbon.

Embodiment 28. The ME-GDE of embodiment 26, wherein the metal is selected from the group consisting of Ni, Ti, and Al.

Embodiment 29. The ME-GDE of embodiment 26, wherein the metal oxide is selected from the group consisting of TiO₂ and Al₂O₃.

Embodiment 30. The ME-GDE of embodiment 26, wherein the metal carbide is selected from the group consisting of WC, W₂C, TiC, MoC, Mo₂C, TaC, VC, and NbC.

Embodiment 31. The ME-GDE of embodiment 26, wherein the metal nitride is selected from the group consisting of WN, W₂N, TiN, MoN, Mo₂N, TaN, VN, and NbN.

Embodiment 32. The ME-GDE of embodiment 26, wherein the metal alloy is stainless steel.

Embodiment 33. The ME-GDE of embodiment 26, wherein the metal composite is steel.

Embodiment 34. The ME-GDE of any one of embodiments 1 to 33, wherein the support material is coated with a wetting agent.

Embodiment 35. The ME-GDE of embodiment 34, wherein the wetting agent comprises one or more species selected from the group consisting of fluorinated polymers, polyvinylidene fluoride (PVDF), polytetrafluoroethylene (PTFE), fluorinated ethylene propylene (FEP), polyvinylchloride (PVC), perfluoroalkoxy polymer resin (PFA), and polychlorotrifluoroethylene (PCTFE).

Embodiment 36. The ME-GDE of any one of embodiments 1 to 35, wherein the support material is permeable to gases and liquids.

Embodiment 37. The ME-GDE of any one of embodiments 1 to 36, wherein the support material is channel-structured.

Embodiment 38. The ME-GDE of any one of embodiments 1 to 36, wherein the support material is pore-structured.

Embodiment 39. The ME-GDE of any one of embodiments 1 to 38, wherein the catalytic phase comprises one or more materials selected from the group consisting of Au, Ag, Cu, Pt, Pd, Sn, Pb, Ir, In, Bi, Au bimetals, Ag bimetals, Cu bimetals, Pt bimetals, Pd bimetals, Sn bimetals, Pb bimetals, Ir bimetals, In bimetals, Bi bimetals, Au alloys, Ag alloys, Cu alloys, Pt alloys, Pd alloys, Sn alloys, Pb alloys, Ir alloys, In alloys, and Bi, alloys.

Embodiment 40. The ME-GDE of any one of embodiments 1 to 39, wherein the catalytic phase comprises a specific electrochemically active surface area in the range of about 0.1 to about 30 (m²/g).

Embodiment 41. The ME-GDE of any one of embodiments 1 to 40, wherein the catalytic phase comprises nanoparticles with an average diameter in the range of about 0.3 nm to about 500 nm.

Embodiment 42. The ME-GDE of any one of embodiments 1 to 40, wherein the catalytic phase comprises nanoparticles with an average diameter in the range of about 0.3 nm to about 5 nm.

Embodiment 43. The ME-GDE of any one of embodiments 1 to 40, wherein the catalytic phase comprises nanoparticles with an average diameter in the range of about 5 nm to about 15 nm.

Embodiment 44. The ME-GDE of any one of embodiments 1 to 40, wherein the catalytic phase comprises nanoparticles with an average diameter in the range of about 15 nm to about 50 nm.

Embodiment 45. The ME-GDE of any one of embodiments 1 to 44, wherein the catalytic phase is adsorbed directly to the support material.

Embodiment 46. The ME-GDE of any one of embodiments 1 to 45, wherein the catalytic phase is adhered to the support with a polymer that is selected from the group consisting of fluoropolymers, proton-exchange ionomers and anion-exchange ionomers.

Embodiment 47. The ME-GDE of any one of embodiments 1 to 45, wherein the catalytic phase is chemically bonded to the support material.

Embodiment 48. The ME-GDE of embodiment 47, wherein the catalytic phase is chemically bonded to the support material with an adhesive.

Embodiment 49. The ME-GDE of embodiment 48, wherein the adhesive is electronically conductive.

Embodiment 50. The ME-GDE of embodiment 48 or 49, wherein the adhesive comprises tetra-ethoxy silane (TEOS).

Embodiment 51. The ME-GDE of any one of embodiments 1 to 50, wherein the membrane phase comprises a thickness in the range of about 2 nm to about 20 nm.

Embodiment 52. The ME-GDE of any one of embodiments 1 to 50, wherein the membrane phase comprises a thickness in the range of about 2 nm to about 6 nm.

Embodiment 53. The ME-GDE of any one of embodiments 1 to 50, wherein the membrane phase comprises a thickness in the range of about 6 nm to about 12 nm.

Embodiment 54. The ME-GDE of any one of embodiments 1 to 50, wherein the membrane phase comprises a thickness in the range of about 12 nm to about 20 nm.

Embodiment 55. The ME-GDE of any one of embodiments 1 to 53, wherein thickness of the membrane phase is tuned to suppress one or more competing electrochemical reactions.

Embodiment 56. The ME-GDE of embodiment 55, wherein the electrochemical reactions comprise one or more reactions selected from the group consisting of methane oxidation reaction, methanol oxidation reaction (MOR), ethanol oxidation reaction (EOR), hydrogen oxidation reaction (HOR), hydrogen evolution reaction (HER), chlorine evolution reaction (CER), oxygen evolution reaction (OER), and oxygen reduction reaction (ORR).

Embodiment 57. A membrane-embedded gas diffusion electrode (ME-GDE), comprising: an electronically conductive support material comprising nanostructured carbon; a catalytic phase comprising Ag; a membrane phase comprising SiO₂; and an ion-conducting phase comprising Nafion; wherein the membrane phase encapsulates the catalytic phase, and wherein the catalytic phase is embedded in the ion-conducting phase.

Embodiment 58. A membrane-embedded gas diffusion electrode (ME-GDE), comprising: an electronically conductive support material; a catalytic phase; and a membrane phase; wherein the catalytic phase is in contact with the electronically conductive support material.

Embodiment 59. A membrane-embedded gas diffusion electrode (ME-GDE), comprising: an electronically conductive support material comprising carbon paper; a catalytic phase comprising Ag; a membrane phase comprising SiO2 or TiO₂; and an ion-conducting phase comprising Sustainion XA-9; wherein the membrane phase encapsulates the catalytic phase and the electronically conductive support material, and wherein the catalytic phase and the electronically conductive support material are embedded in the ion-conducting phase.

While the invention has been described with reference to particular aspects, it will be understood by those skilled in the art that various changes may be made and equivalents may be substituted for elements thereof without departing from the scope of the invention. In addition, many modifications may be made to a particular situation or material to the teachings of the invention without departing from the scope of the invention. Therefore, it is intended that the invention not be limited to the particular aspects disclosed but that the invention will include all aspects falling within the scope and spirit of the appended claims.

1. A membrane-embedded gas diffusion electrode (ME-GDE), comprising:
an electronically conductive support material;
a catalytic phase;
a membrane phase; and
an ion-conducting phase;
wherein the catalytic phase is dispersed in the ion-conducting phase, and wherein the ion-conducting phase is in contact with the electronically conductive support material.

2. The ME-GDE of claim 1, wherein the membrane phase comprises one or more oxides selected from the group consisting of MgO, MgO₂, MnO, MnO₂, SiO, SiO₂, CeO₂, TiO₂, SnO₂, Al₂O₃, and ZrO₂.

3. (canceled)

4. (canceled)

5. The ME-GDE of claim 1, wherein the membrane phase comprises
a first layer comprising one or more oxides selected from the group consisting of MgO, MgO₂, MnO, MnO₂, SiO, SiO₂, CeO₂, TiO₂, SnO₂, Al₂O₃, and ZrO₂; and
a second layer comprising one or more functionalized organic polymers selected from the group consisting of poly-dimethyl-siloxane (PDMS), organo-siloxane composites, sodium dodecyl sulfate (SDS), poly-tetrafluoroethylene, tetra-ethoxy silane (TEOS), cellulose acetates, polyamides, polyimides, and polysulfones.

6. The ME-GDE of claim 1, wherein the membrane phase is permeable to one or more ions selected from the group consisting of H⁺, Li⁺, Na⁺, K⁺, Cs⁺, OH⁻, CO₂H⁻, and CO₃²⁻, and wherein the membrane phase is impermeable to one or more ions selected from the group consisting of S²⁻, SO₃²⁻, SO₄²⁻, NO₂⁻, NO₃⁻, PO₄³⁻, PO₃H²⁻, F⁻, Cl⁻, Br⁻, and I⁻.

7. The ME-GDE of claim 1, wherein the membrane phase is permeable to one or more molecules selected from the group consisting of CO, CO₂, H₂O, and C₁-C₄ alcohols, and wherein the membrane phase is impermeable to one or more molecules selected from the group consisting of NO, O₂, C₂-C₆ alkanes, C₁-C₆ alkenes, and C₁-C₆ alkynes.

8.-11. (canceled)

12. The ME-GDE of claim 1, wherein the surface of the membrane phase is modified with one or more functional groups selected from the group consisting of imidazoles, amines, and amides.

13. The ME-GDE of claim 1, wherein the membrane phase covers part of the catalytic phase.

14. The ME-GDE of claim 1, wherein the membrane phase encapsulates the catalytic phase.

15. The ME-GDE of claim 1, wherein the membrane phase is in direct contact with the ion-conducting phase.

16. (canceled)

17. (canceled)

18. The ME-GDE of claim 1, wherein the membrane phase is interspersed in the electronically conductive support material and is not in direct contact with the ion-conducting phase.

19. The ME-GDE of claim 1, wherein the membrane phase partially encapsulates the electronically conductive support material.

20. The ME-GDE of claim 1, wherein the ion-conducting phase is selective for the transport of one or more cations and one or more anions.

21.-23. (canceled)

24. The ME-GDE of claim 1, wherein the ion-conducting phase comprises one or more ionomers selected from the group consisting of sulfonated fluorocarbon polymers, sulfonated poly(ether ether ketone), sulfonated polystyrene, imidazolium-functionalized styrene, imidazolium-functionalized vinyl-benzene chloride, and phosphoric acid-doped polybenzimidazole.

25. (canceled)

26. The ME-GDE of claim 1, wherein the support material comprises one or more materials selected from the group consisting of nanostructured carbon, metals, and metal oxides, metal carbides, metal nitrides, MXenes, metal alloys, and metal composites.

27.-38. (canceled)

39. The ME-GDE of claim 1, wherein the catalytic phase comprises one or more materials selected from the group consisting of Au, Ag, Cu, Pt, Pd, Sn, Pb, Ir, In, Bi, Au bimetals, Ag bimetals, Cu bimetals, Pt bimetals, Pd bimetals, Sn bimetals, Pb bimetals, Ir bimetals, In bimetals, Bi bimetals, Au alloys, Ag alloys, Cu alloys, Pt alloys, Pd alloys, Sn alloys, Pb alloys, Ir alloys, In alloys, and Bi, alloys.

40.-44. (canceled)

45. The ME-GDE of claim 1, wherein the catalytic phase is adsorbed directly to the support material.

46.-50. (canceled)

51. The ME-GDE of claim 1, wherein the membrane phase comprises a thickness in the range of about 2 nm to about 20 nm.

52.-54. (canceled)

55. The ME-GDE of claim 1, wherein thickness of the membrane phase is tuned to suppress one or more competing electrochemical reactions selected from the group consisting of methane oxidation reaction, methanol oxidation reaction (MOR), ethanol oxidation reaction (EOR), hydrogen oxidation reaction (HOR), hydrogen evolution reaction (HER), chlorine evolution reaction (CER), oxygen evolution reaction (OER), and oxygen reduction reaction (ORR).

56. (canceled)

57. (canceled)

58. A membrane-embedded gas diffusion electrode (ME-GDE), comprising:
an electronically conductive support material;
a catalytic phase; and
a membrane phase;
wherein the catalytic phase is in contact with the electronically conductive support material.

59. A membrane-embedded gas diffusion electrode (ME-GDE), comprising:
an electronically conductive support material comprising carbon paper;
a catalytic phase comprising Ag;
a membrane phase comprising SiO₂ or TiO₂; and
an ion-conducting phase comprising Nafion;
wherein the membrane phase encapsulates the catalytic phase and the electronically conductive support material, and wherein the ion-conducting phase is distributed within the catalytic phase and the electronically conductive support material.
